(19) United States
(12) Patent Application Publication
(10) Pub. No.: US 2011/0193335 A1
(43) Pub. Date: Aug. 11, 2011

(54) RETROREFLECTIVE SECURITY ARTICLES

(76) Inventors: Kenton D. Budd, Woodbury, MN (US); Christopher K. Haas, St. Paul, MN (US); Matthew H. Frey, Cottage Grove, MN (US); Vivek Krishnan, St. Paul, MN (US); Caroline M. Ylitalo, Stillwater, MN (US); Lynn E. Lorimor, Minneapolis, MN (US)

(21) Appl. No.: 12/808,559

(22) PCT Filed: Dec. 4, 2008
(86) PCT No.: PCT/US08/85459

§ 371 Date: Apr. 5, 2011

Related U.S. Application Data
(60) Provisional application No. 61/016,238, filed on Dec. 21, 2007.

(51) Int. Cl. B42D 15/00; G02B 5/128

(52) U.S. Cl. 283/75; 283/87; 359/536; 359/540

(57) ABSTRACT

Security laminates and articles wherein the security laminate includes a first substrate having a first major surface and a second major surface; a plurality of retroreflective elements affixed along the first major surface of the substrate, the retroreflective elements including a solid spherical core comprising an outer core surface, the outer core surface providing a first interface; a first complete concentric optical interference layer having an inner surface overlying core surface and an outer surface, the outer surface of the first complete concentric optical interference layer providing a second interface; a second complete concentric optical interference having an inner surface overlying the outer surface of the first complete concentric optical interference layer and an outer surface, the outer surface of the second complete concentric optical interference layer providing a third interface; the security laminate is retroreflective. Security articles include the foregoing security laminate affixed to a major surface of a second substrate.

### BACKGROUND

Documents of value requiring identification and authentication such as passports, identification cards, entry passes, ownership certificates, financial instruments, and the like are often assigned to a particular person by personalization data that often contains overt and covert security features. Overt security features are those that can be quickly detected (e.g., in less than a second) while covert security features are those that take some time, require manipulation of the security document and/or require the use of a tool. Some documents of value, such as passports and identification cards, also include a laminate containing overt and/or covert security features on top of the personalization data to protect the data against forgery. Retroreflectivity has been shown to be one of the most secure covert features available.

“Retroreflectivity” refers to the ability of an article, if engaged by a beam of light, to reflect that light substantially back in the direction of the light source. Retroreflective constructions are known in the art and generally include a plurality of transparent spherically shaped retroreflective elements affixed to a substrate along at least one major surface thereof. Exemplary retroreflective articles include security laminates used for documents of value and the like. In beaded retroreflective constructions, substantially collimated light (e.g., a beam of light from an automobile headlight) enters the front surfaces of the retroreflective elements, is refracted, and impinges on a reflector at or near the back surfaces of the elements. The optical characteristics of the retroreflective elements and reflectors can be tailored so that a significant amount of light is returned antiparallel or nearly antiparallel to the incident light to reveal retroreflective patterns that, under diffuse or ambient light, are not otherwise noticeable.

Retroreflective patterns can be especially useful in security applications, especially where the retroreflective pattern provides a covert security feature. Many retroreflective security laminates provide an image (i.e., retroreflective pattern) that is considerably brighter in retroreflective lighting than the rest of the laminate (background retroreflectivity). Using a collimated light tool, the identification of such an image allows for the immediate authentication of the laminate while the absence of the image or the presence of a modified image would indicate tampering or falsification of the laminate. Hiding power and contrast are often viewed as significant features in a retroreflective security article. Hiding power is the ability to hide data under retroreflective lighting and is related to the inherent brightness of the retroreflective material. Poor hiding power makes authentication difficult when the data interferes with the retroreflective pattern. Contrast is the intensity/color difference between the retroreflective pattern and background. Poor contrast (low retroreflective intensity/color difference relative to background) means that the retroreflective pattern is less discernable, thus making authentication difficult.

Spherical, solid bead cores supporting a single complete concentric optical interference layer are known to produce covert retroreflective colors and retrochromic patterns. The term “retrochromic” refers to the ability of an article or a region thereof, when viewed in retroreflective mode, to exhibit a retroreflected color that is different from the color exhibited when the object or region is viewed in diffuse or ambient lighting. The art has also noted an effect of the refractive index of a single complete concentric optical interference layer on the saturation and intensity of retrochromic colors. It has been suggested that the medium behind the optical interference layer (e.g., between the retroreflective element and the substrate or backing) can provide a high refractive index contrast interface between the coating and the medium.

### SUMMARY

Improvements are desired in retroreflective elements, in security laminates comprising such elements and security articles comprising such laminates.

In one aspect of the invention, a security laminate with retroreflective elements is provided, comprising:
A first substrate having a first major surface and a second major surface;
A plurality of retroreflective elements affixed along the first major surface of the substrate, the retroreflective elements comprising:
   a solid spherical core comprising an outer core surface, the outer core surface providing a first interface;
   a first complete concentric optical interference layer having an inner surface overlying the core surface and an outer surface, the outer surface of the first complete concentric optical interference layer providing a second interface;
   a second complete concentric optical interference having an inner surface overlying the outer surface of the first complete concentric optical interference layer and an outer surface, the outer surface of the second complete concentric optical interference layer providing a third interface; and
   the security article is retroreflective.

In other aspects, the security laminate comprises the foregoing retroreflective elements which further comprise a third complete concentric optical interference layer overlying the second surface of the second complete concentric optical interference layer, the third complete concentric optical interference layer having an inner surface overlying the outer surface of the second complete concentric optical interference layer and an outer surface, the outer surface of the third complete concentric optical interference layer providing a fourth interface.

In another aspect, a security article is provided, comprising the security laminate as previously described wherein a first portion of the retroreflective elements are affixed along the first major surface of the first substrate in a first region; and wherein a second portion of the retroreflective elements are affixed along the first major surface of the first substrate in a second region, the first portion of retroreflective elements providing a first retroreflective color and the second portion of retroreflective elements providing a second retroreflective color, the security laminate being transparent in diffuse lighting.

Unless otherwise indicated, the terms used herein are to be construed in a manner consistent with the understanding of those skilled in the art. For the sake of clarity, the following terms are to be understood as having the meanings given herein:

“Overt security feature” refers to a feature that can be authenticated without the use of a tool.

“Covert security feature” refers to a feature that requires a tool or requires manipulation of the security material.

“Tamper resistance” refers to a security feature which reduces the ability to alter the material to form a counterfeit.

“Tamper evidence” refers to a security feature which causes an attempt at tampering to become obvious by removing a security feature or triggering another security feature.

“Security laminate” refers to a material that is bonded to a security document so that some of the data on the document of value is protected by the laminate.

“Bead-bond” refers to the layer of material(s) that holds the retroreflective elements.

“Light” refers to electromagnetic radiation having one or more wavelengths in the visible (i.e., from about 380 nm to about 780 nm), ultraviolet (i.e., from about 200 nm to about 380 nm), and/or infrared (i.e., from about 780 nm to about 100 micrometers) regions of the electromagnetic spectrum.

“Refractive index” refers to the index of refraction at a wavelength of 589.3 nm corresponding to the sodium yellow d-line, and a temperature of 20° C., unless otherwise specified. The term “refractive index” and its abbreviation “RI” are used interchangeably herein.

“Retroreflective mode” refers to a particular geometry of illumination and viewing that includes engaging an article with a beam of light and viewing the illuminated article from substantially the same direction, for example within 5 degrees, 4 degrees, 3, degrees, 2 degrees, or 1 degree of the illumination direction. Retroreflective mode can describe the geometry in which a person views an article or the geometry in which an instrument measures the reflectivity of an article.

“Retroreflective brightness” refers to the effectiveness with which an object or ensemble of objects, for example a retroreflective element or an ensemble of retroreflective elements, or for example an article comprising one or more retroreflective elements, returns incident light back in the direction (or nearly in the direction) from which it came. Retroreflective brightness relates to the intensity of light that is retroreflected from an object, versus the intensity of light that is incident on the object.

“Coefficient of Retroreflection” (Ra) is a standard measure of the retroreflective brightness of an object, and can be expressed in units of candelas per square meter per lux, or Cd/lux/m², or Cpl. These units and measurement instruments that report the coefficient of retroreflection in such units, weight the retroreflective brightness with the luminosity function. The luminosity function describes the dependence of human eye sensitivity on the wavelength of light and is non-zero for wavelengths between approximately 380 nanometers and 780 nanometers, thus defining the visible region of the electromagnetic spectrum.

“Complete concentric optical interference layer” or “optical interference layer” refers to a translucent or transparent coating surrounding and directly adjacent to essentially the entire surface (i.e., not only a selected portion of the surface, for example only the back surface) of a bead core or surrounding and directly adjacent to the outside surface of another, inner complete concentric optical interference layer, the complete concentric optical interference layer being of essentially uniform thickness.

“Reflector” refers to a specular or diffuse reflective material that is placed in a retroreflective article at or near the focal position behind a retroreflective element in a retroreflective article. The reflective material can be a diffuse light-scattering or metallic material, or one or more layers of transparent material components that creates one or more reflective interfaces.

“Region” refers to a continuous portion of an object. A region typically has a boundary or general extent that is discernible to a viewer.

For clarity, in embodiments where more than one reflector is present at or near the focal position behind a retroreflective element in a beaded retroreflective article, the material in contact with or closest to the outer surface of the bead is designated the “primary reflector.” Additional reflectors farther from the back surface of the bead core or retroreflective element are designated as “auxiliary reflectors.” A stack of directly adjacent dielectric layers is considered to be a single “reflector” for the purpose of designating primary and auxiliary reflectors. For example, an article comprising a retroreflective element having two or more complete concentric optical interference layers with back surface embedded in a pigmented binder has complete concentric optical interference layers as a primary reflector and a pigmented binder as an auxiliary reflector.

Those skilled in the art will more fully appreciate the scope of the present invention upon consideration of the remainder of the disclosure including the Detailed Description, the drawings and the appended claims.

### BRIEF DESCRIPTION OF THE DRAWINGS

The various Figures herein are not to scale but are provided as an aid in the description of the embodiments. In describing embodiments of the invention, reference is made to the Figures in which features of the embodiments are indicated with reference numerals, with like reference numerals indicating like features, and wherein:

FIG. 1 is a cross-sectional view of an embodiment of a retroreflective element according to the invention;

FIG. 2 is a cross-sectional view of another embodiment of a retroreflective element according to the invention;

FIG. 3 is a cross-sectional isometric view of an exemplary embodiment of retroreflective article according to the present invention;

FIG. 4 is a cross-sectional isometric view of another exemplary embodiment of retroreflective article according to the present invention;

FIG. 5 is a cross-sectional isometric view of still another exemplary embodiment of retroreflective article according to the present invention;

FIG. 6 is a schematic diagram of a process for making retroreflective elements according to the present invention;

FIG. 7 is a cross-sectional view of security laminate having a base sheet and a plurality of retroreflective elements affixed thereto, according to an embodiment of the invention;

FIG. 8 is a top plan view of a security laminate, as viewed in a retroreflective mode, showing a retroreflective pattern thereon, according to another embodiment of the invention;

FIG. 9 is an enlarged section of the circular section 9 shown in FIG. 8; and

FIG. 10 is a perspective view of a security article showing the security laminate of FIG. 8 attached thereto, as viewed in a retroreflective mode, according to another embodiment of the invention.

### DETAILED DESCRIPTION

The present invention provides retroreflective elements in the form of coated beads and security laminates and articles comprising such retroreflective elements. Retroreflective elements according to the invention and security laminates and articles comprising such retroreflective elements exhibit enhanced retroreflective brightness due to interference phenomena arising from the retroreflective elements that are comprised of two or more complete concentric optical interference layers deposited over a solid spherical bead core. Interference-enhanced retroreflectivity includes the achievement of enhanced retroreflective brightness without retroreflective color as well as the achievement of a combination of enhanced retroreflective brightness and retroreflective color through the design and deposition of two or more complete concentric optical interference layers on a solid spherical core. Higher retroreflective brightness is achieved for the retroreflective elements and articles of the invention as compared with the retroreflective brightness for similar articles comprising other retroreflective elements having spherical bead cores but having no more than one complete concentric optical interference layer (e.g., one layer or no layer).

Retroreflective brightness can be measured for various angles between the incident and reflected light (the observation angle) but is not limited to a particular range of angles. For some applications such as security laminates, effective retroreflectivity is desired at a return angle of zero degrees (anti-parallel to the incident light).

In the present application, visible light is used for the evaluation of retroreflective brightness which is described by the coefficient of retroreflection (Ra). Articles according to the invention that comprise retroreflective elements having two complete concentric optical interference layers deposited over solid spherical cores exhibit coefficient of retroreflection (Ra) values that are greater than similar articles having retroreflective elements which do not include two or more concentric optical interference layers (e.g., a solid spherical core with zero or only one concentric optical interference layer). Articles constructed according to the invention may or may not include an auxiliary reflector as a part thereof, and the aforementioned improvements in the coefficient of retroreflection are observed for articles that include an auxiliary reflector as well as for articles that lack an auxiliary reflector. For articles that do not include an auxiliary reflector, the coefficient of retroreflection is increased in some embodiments by a factor greater than 2.5, in some embodiments by a factor greater than 3, in some embodiments by a factor greater than 4, in some embodiments by a factor greater than 5, in some embodiments by a factor greater than 6, and in some embodiments by a factor greater than 7 as compared with other articles having no auxiliary reflector but which include retroreflective elements in the form of solid spherical cores supporting zero or one concentric optical interference layer. For articles that include an auxiliary reflector, the coefficient of retroreflection is increased in some embodiments by a factor greater than 2.5, in some embodiments by a factor greater than 3, and in some embodiments by a factor greater than 3.5 as compared with other articles having an auxiliary reflector and retroreflective elements consisting of solid spherical cores supporting zero or one concentric optical interference layer.

Articles of the invention that comprise retroreflective elements having three complete concentric optical interference layers deposited over a solid spherical core, exhibit coefficient of retroreflection (Ra) values that are greater than the same articles with the same solid spherical core, but supporting zero or only one optical interference layer. Improvements in the coefficient of retroreflection are observed for articles that include an auxiliary reflector as well as for articles that do not include an auxiliary reflector. Articles that do not include an auxiliary reflector show increases in the coefficient of retroreflection in some embodiments by a factor greater than 3, in some embodiments by a factor greater than 4, in some embodiments by a factor greater than 6, in some embodiments by a factor greater than 8, in some embodiments by a factor greater than 10, in some embodiments by a factor greater than 12, and in some embodiments by a factor greater than 14. Articles having an auxiliary reflector still exhibit an increase in the coefficient of retroreflection in some embodiments by a factor greater than 3, in some embodiments by a factor greater than 4, in some embodiments by a factor greater than 5, and in some embodiments by a factor greater than 6.

Retroreflective elements useful in the present invention include a solid spherical core with two or more coated layers applied to the core, the two or more coated layers forming complete concentric optical interference layers that surround the core. The first or innermost optical interference layer covers and is adjacent to the outer surface of the solid spherical bead core. A second complete concentric optical interference layer covers and is adjacent to the outer surface of the first or innermost concentric optical interference layer. While complete concentric optical interference layers typically cover the entire surface of a solid spherical core, an optical interference layer may include small pinhole defects or small chip defects that penetrate the layer without impairing the optical properties of the retroreflective element. Optionally, retroreflective elements provided by the present invention may comprise additional complete concentric optical interference layers with each successive optical layer covering a previously deposited layer (e.g., a third concentric optical interference layer covers the second concentric optical interference layer; a fourth layer covers the third layer, etc.). By concentric, what is meant is that each such optical interference layer on a given core is spherically shaped and substantially uniform in thickness around the entire sold core while allowing for some defects, as noted. In general, each concentric optical interference layer shares its center with the center of the solid core.

It is within the scope of the present invention to include a variety of retroreflective elements as components of any of a variety of security laminates and articles. In some embodiments, an article will comprise retroreflective elements according to the present invention while other retroreflective elements may be outside the scope of the invention. For example, some of the retroreflective elements may have no concentric optical interference layers. In some embodiments, the retroreflective elements may be within the scope of the invention but may comprise optical interference layers with varying thicknesses. In other words, the retroreflective elements may comprise different constructions in which the concentric optical interference layers are of different materials and/or different thicknesses from one retroreflective element to the next. In such embodiments, the first or innermost optical interference layer may vary in thickness by more than twenty five percent from one retroreflective element to another. In some embodiments, one or more additional coated layers may not be concentrically coated. In still other embodiments, security laminates and articles may comprise a combination of retroreflective elements, at least a portion of the retroreflective elements comprising two complete concentric optical interference layers, at least another portion of the retroreflective elements comprising three complete concentric optical interference layers and still another portion of the retroreflective elements comprising zero or one complete concentric optical interference layer.

In some embodiments, the coating design provides lower reflection or antireflection-like properties to the front surface, while providing desired reflectivity at the rear surface, resulting in improved brightness or ability to read through the layer. Complete concentric optical interference layers are applied to a spherical core to provide a retroreflective element with enhanced retroreflective brightness characteristics. In other words, when placed in an article, the retroreflective elements provide a retroreflective brightness that is greater than retroreflective brightness of identical articles comprising other forms of retroreflective elements or the like. In some embodiments, the color of the retroreflected light is the same or similar to that of the incident light. For example, the retroreflected light exhibits little or no color for white incident light. In still other embodiments, the optical interference layers are applied to the core so that, when placed in an article, the retroreflective elements provide a retroreflective color. In some embodiments, a discernable pattern on the surface of an article or substrate is viewable in the retroreflective mode but not under diffuse lighting. In some embodiments, retrochromic characteristics of the retroreflective elements may also be used to enhance the existing color of an article, i.e., the retroreflected color of the retroreflective elements matches the color of the article when viewed in diffuse lighting. In some embodiments, the article comprises retroreflective regions of retroreflective elements so that, when viewed in the retroreflective mode, the article displays a pattern or design of one retroreflected color and a background of another retroreflective color. In some embodiments, the retroreflective pattern or design comprises two or more colors.

A complete, concentric optical interference layer for visible light on a bead core creates two reflective interfaces at the back of a retroreflective element. The thickness of the optical interference layer is such that the optical thickness results in a constructive or destructive interference condition for one or more wavelengths that fall within the wavelength range corresponding to visible light. “Optical thickness” refers to the physical thickness of a coating multiplied by its index of refraction. Such constructive or destructive interference conditions are periodic with increasing optical thickness for the optical interference coating, up to the coherence length of the illumination. With increasing coating thicknesses, constructive interference for a given wavelength will occur first when the optical path through the coating and back again, combined with any phase inversions caused by the sign of refractive index change at either or both interfaces, leads to a phase difference of 2π radians for the two components of light that reflect from the two interfaces. With further increase in thickness, the same constructive interference condition will be achieved again when the phase difference is equal to 4π radians. Similar behavior will occur for further increases in thickness. The thickness period that separates successive occurrences of the constructive interference condition (that is, the increment in thickness for the coating which leads to repetition of nominally the same interference condition for a given wavelength in vacuo of light that is reflected from the two surfaces of the coating) is given by one half of the wavelength in vacuo divided by the index of refraction of the coating. Each occurrence of a given interference condition with increasing coating thickness from zero nanometers can be assigned a period number (e.g., n=1,2,3 . . . ). When retroreflective elements comprising an optical interference layer are illuminated with broadband light (light comprising many wavelengths, for example white light), a range of interference effects characterizes the retroreflection behavior for the different wavelengths. These optical phenomena become substantially more complex when more than one optical interference layer is applied to the bead core. And, with respect to white light illumination, the measurement or observation of retroreflected color and the determination of a coefficient of retroreflection (Ra) (with its inherent relation to the luminous intensity function) become more complicated.

The retroreflected color and the retroreflective brightness for retroreflective articles comprising retroreflective elements having two or more complete concentric optical interference layers exhibit periodic behaviors dependent on optical interference layer thickness(es). Retroreflective elements made with multiple complete concentric optical interference layers, or articles comprising such retroreflective elements, exhibit oscillations of magnitude (e.g., peaks and valleys) in the coefficient of retroreflection (Ra) as one or more of the interference layers increases in thickness. In some embodiments, high coefficient of retroreflection is achieved for white light illumination without the generation of color for the retroreflected light. In other embodiments, high coefficient of retroreflection is generated for white light illumination accompanied by the generation of retroreflected light of color. In some embodiments, the articles can include regions of retroreflective elements that provide any of a variety of displays or designs having a distinctive appearance and/or color under diffuse lighting, as well as a retroreflected color or lack of retroreflected color with a high coefficient of retroreflection under white light illumination when viewed in a retroreflective viewing mode.

The coherence length for non-laser light (for example light produced by an incandescent lamp, a gas discharge lamp, or a light-emitting diode) limits the values of n (and hence the total coating thickness) for which strong interference effects are observed. Interference effects tend to vanish for thicknesses corresponding to n=10 or more, and are greatly diminished at about half of that thickness. For retroreflective elements partially embedded in adhesive with an index of refraction of approximately 1.55, illuminated on their air-exposed side, and comprising a single complete concentric optical interference coating with refractive index of about 2.4, five peaks in retroreflective brightness are established by interference coatings of thicknesses ranging from zero nanometers up to approximately 600 nm. These physical thickness values correspond to an optical thickness of up to about 1500 nm. For articles comprising retroreflective elements with a single complete concentric optical interference coating having a refractive index of about 1.4, five peaks in retroreflective brightness are established by interference coatings of thicknesses ranging from zero nanometers up to approximately 1200 nanometers, corresponding to an optical thickness of less than 1700 nm. In some embodiments, a visible light interference layer comprises a coating with an optical thickness less than about 1500 nm.

Retroreflective security laminates and articles according to the present invention may optionally include one or more auxiliary reflectors wherein the retroreflective elements and the auxiliary reflector act collectively to return fractions of incident light back in the direction of the source. In some embodiments, a suitable auxiliary reflector is a diffuse light-scattering pigmented binder into which retroreflective elements are partially embedded. A pigmented binder is an auxiliary reflector when the pigment type and loading are selected to create a diffuse-scattering material (for example, greater than 75% diffuse reflection), as opposed to when the selection of pigment and loading are done simply to color a bead binder. Examples of pigments that lead to diffuse scattering include titanium dioxide particles and calcium carbonate particles.

In other embodiments, a suitable auxiliary reflector comprises a specular-pigmented binder into which retroreflective elements are partially embedded. Examples of specular pigments include mica flakes, titanated mica flakes, pearlescent pigments, and nacreous pigments.

In still other embodiments, a suitable auxiliary reflector is a metal thin film that is selectively placed behind the retroreflective element, in a retroreflective article.

In still another embodiment, a suitable auxiliary reflector is a dielectric stack of thin films selectively placed behind the retroreflective element, in a retroreflective article.

In the case of a retroreflective article wherein the index of refraction of the core of the retroreflective elements is between 1.5 and 2.1 and the front surface of the retroreflective elements is exposed to air, auxiliary reflectors can be placed adjacent to the back side of the retroreflective elements. In the case of a retroreflective article wherein the retroreflective elements is enclosed on its front surface with a transparent material that contacts its front surface or is covered on its front surface by water when in use, auxiliary reflectors can be advantageously used and can be spaced behind the back surface of the retroreflective elements.

In some embodiments, the present invention provides retroreflective articles for which the need for auxiliary reflectors is minimized. Consequently, use of the retroreflective elements of the invention can provide enhanced retroreflective brightness as well as reduced manufacturing costs as compared with the cost of manufacturing similar articles that require auxiliary reflectors or alternative primary reflectors. Moreover, the elimination of alternative or auxiliary reflectors can improve the ambient-lit appearance and durability of retroreflective articles made with retroreflective elements according to the invention.

Retroreflective articles made without auxiliary reflectors typically include a plurality of retroreflective elements partially embedded in a transparent (colored or non-colored), non-light-scattering, non-reflective binder (for example a clear, colorless, polymeric binder) and wherein the focal position for light incident on the retroreflective elements is within the binder or at the interface between the retroreflective element and the binder. In some constructions, retroreflective elements include spherical cores in the form of microspheres having an index of refraction near 1.9. The retroreflective elements are partially embedded in a clear, colorless binder and their front surfaces are exposed to air, providing focal positions near the interface between the back side of the retroreflective elements and the binder. It has been noted that multiple complete concentric optical interference layers applied to the microspheres can increase the coefficient of retroreflection (Ra).

Articles comprising microspheres with a 1.9 index of refraction but without concentric optical interference layers, embedded in a clear acrylate adhesive, have exhibited Ra values of approximately 8 Cd/lux/m² at −4 degrees entrance angle and 0.2 degrees observation angle. The application of a single complete concentric optical interference layer of low index of refraction (for example 1.4) or high index of refraction (e.g., 2.2) to the microspheres increased the Ra to as high as 18 Cd/lux/m² or as high as 30 Cd/lux/m², respectively. In the present invention, the use of two complete concentric optical interference layers over the microsphere core, when placed in an article as described above, have provided an increase in the Ra to as high as 59 Cd/lux/m². When articles have been made comprising microspheres having three complete concentric optical interference layers, the Ra has increased to as high as 113 Cd/lux/m². Thus, the retroreflective elements of the invention and articles made with such retroreflective elements exhibit useful levels of retroreflection in the absence of auxiliary reflectors.

Referring now to the drawings, FIG. 1 illustrates, in cross-section, an embodiment of a retroreflective element 100 according to the present invention. The retroreflective element 100 includes a transparent substantially spherical core 110 having thereon a first concentric optical interference layer 112. Core 110 contacts optical interference layer 112 at first interface 116. Second concentric optical interference layer 122 overlies the first concentric optical interference layer 112. Layer 122 has an interior surface that contacts the exterior or outermost surface of first layer 112, forming a second interface 126 and an exterior surface that forms the outermost surface of the element 100 and provides a third interface 124. The first and second concentric optical interference layers 112, 122 are substantially uniform over the surface of spherical core 110.

Light is reflected at interfaces between materials possessing different refractive indexes (e.g., having a difference in refractive indexes of at least about 0.1). A sufficient difference in the refractive indexes of the core 110 and first optical interference layer 112 gives rise to a first reflection at first interface 116. Similarly, a sufficient difference in the refractive indexes of first optical interference layer 112 and second optical interference layer 122 gives rise to a second reflection at second interface 126. A sufficient difference in the refractive indexes of second optical interference layer 122 and any background medium (e.g., vacuum, gas, liquid, solid) contacting second optical interference layer 122 gives rise to a third reflection at third interface 124 of the retroreflective element 100.

Incident beam of light 130 is shown in FIG. 1 as being directed at retroreflective element 100. Light 130 is largely transmitted through both the second optical interference layer 122 and the first optical interference layer 112 and enters core 110. A portion of the incident light 130 may be reflected at third interface 124 or at second interface 126 or first interface 116. Retroreflection results from the portion of light 130 that enters core 110 and is focused by refraction onto the opposite side of core 110. The refracted light 135 encounters first interface 116 at the back of core 110, some of refracted light 135 is reflected back as reflected light 140 towards the front of the retroreflective element 100 where it ultimately emerges from the retroreflective element as retroreflected light 150 in a direction that is substantially anti-parallel to incident light 130. Similarly, another portion of the focused light passes through optical interference layer 112 and is reflected back as reflected light 142 at second interface 126. Reflected light 142 ultimately emerges from the retroreflective element as retroreflected light 152 in a direction that is substantially anti-parallel to incident light 130. Still another portion of the focused light passes through both of the optical interference layers 112 and 122 and is reflected back at third interface 124 as reflected light 144. The exterior surface of the optical interference layer 122 forms third interface 124 with the medium in which the retroreflective element 100 is disposed (e.g., gas, liquid, solid, or vacuum). Reflected light 144 ultimately emerges from the retroreflective element as retroreflected light 154 in a direction that is substantially anti-parallel to incident light 130. A portion of incident light is not reflected in the manner described but passes entirely through the concentrically coated bead. Another portion of the incident light is reflected from the front surface of the retroreflective element and never enters the bead core.

Interference between reflected light 140, 142, 144 and in turn retroreflected light 150, 152, 154 may give rise to a change in intensity or color of the retroreflected light. A plurality of retroreflective elements, like the elements 100, can provide bright retroreflection, including high coefficient of retroreflection, and/or retrochromic properties that enhance the appearance of an article by providing a covert color, design, message or the like. A desired interference effect can be obtained by manufacturing the retroreflective element 100 with optical interference layers 112 and 122 of different materials and by selecting the thicknesses and refractive indexes of those materials so that the aforementioned retroreflected light 150, 152, 154 desirably interfere with each other.

In some embodiments, the proper selection of materials, thicknesses and refractive indexes for the optical interference layers 112 and 122, retroreflective element 100 can provide retroreflected light 150, 152, 154 that is brighter than retroreflected light (e.g., in the form of higher coefficient of retroreflection) from uncoated beads, for example. When incorporated in an article, a plurality of retroreflective elements 100 provide retroreflective properties that enhance the visibility of the article. Constructive interference between reflected light 140, 142, 144 and in turn retroreflected light 150, 152, 154 gives rise to unexpected increases in the brightness or intensity of the retroreflected light, for example visible retroreflected light. In some embodiments, coating thicknesses for the two optical interference layers can be optimized to provide maximum retroreflectivity when the layers are alternating layers of silica and titania and where the core comprises a glass bead having a diameter measuring from about 30 μm to about 90 μm. In such embodiments, a first optical interference layer 112 of silica having a thickness between about 85 and 115 nm, and typically about 110 nm, and a second optical interference layer 122 of titania having a thickness between about 45 nm and 125 nm, and typically about 60 nm, has provided significantly enhanced coefficient of retroreflection (Ra) when the retroreflective elements are partially embedded as a monolayer in acrylate adhesive.

Reflection of light at an interface between materials is dependent on the difference in the refractive indexes of the two materials. Materials for the cores and the optical interference layers may be selected from any of a variety of materials, as described herein. The selected materials may comprise either high or low refractive index materials, as long as sufficient differences in refractive indexes are maintained between that of the core 110 and first optical interference layer 112, between the first optical interference layer 112 and second optical interference layer 122, and between the second optical interference layer 122 and the background medium against which the retroreflective element 100 is intended to be placed, and as long as the core provides the desired refraction. Each of these differences should be at least about 0.1. In some embodiments, each of the differences between the adjacent layers should be at least about 0.2. In other embodiments, the differences are at least about 0.3, and in still other embodiments, the differences are at least about 0.5. The refractive index of optical interference layer 112 may be either greater than or less than the refractive index of core 110. In some embodiments, the choice of refractive index, and the corresponding choice of materials used, will be determined by the choice of the medium that contacts the exterior surface of the retroreflective element 100 to form third interface 124.

The refractive indexes of core 110, first optical interference layer 112, second optical interference layer 122, the medium against which the back side of retroreflective element 100 is intended to be placed, and the medium that contacts the front side of the retroreflective element are desirably selected to control the focal power of the retroreflective element as well as the strength of reflections from interfaces 116, 126 and 124.

Completely concentrically coated retroreflective elements with a front surface surrounded by air and a rear surface surrounded by a medium having a refractive index of about 1.55, such as a polymer binder) and illuminated with white light, the photopically weighted net intensity of reflected light, to the extent that it is determined by the sequence of transmission and reflection events for antiparallel rays of retroreflected light as they enter and leave the retroreflective element, can vary with coating thickness or thicknesses. The term “photopically weighted net intensity of reflected light” refers to the relative fraction of white light intensity, weighted by the luminosity function, that remains after incident light on a retroreflective element is partially transmitted into the retroreflective element, partially reflected at the back of the retroreflective element, and partially transmitted upon leaving the retroreflective element antiparallel to the incident light direction, accounting only for losses of intensity that result from interfacial reflections and interference effects. When a thin single interference layer of a given material is chosen resulting in a certain index difference at each of the two reflecting interfaces (for example, silica on a 1.93 RI bead core), the photopically weighted net intensity of reflected light can vary by a factor of at least about 6 depending on the thickness of the coating. The photopically weighted net intensity of reflected light produced by the three interfaces established by two coating layers (for example, of amorphous silica and titania on a 1.93 refractive index bead core) can vary by a factor of at least 12, depending on the exact thickness of the two concentric coatings. For some choices of coatings and thicknesses, the photopically weighted net intensity of reflected light can be reduced versus an uncoated retroreflective element.

In some embodiments, the core 110 may be selected to have an index of refraction suitable for use when the entry medium (that is, the medium adjacent the front surfaces of the retroreflective elements) is air. In some embodiments, when the entry medium is air, the index of refraction of the core 110 is between about 1.5 and 2.1. In other embodiments, the index of refraction of the core is between about 1.7 and about 2.0. In other embodiments, the index of refraction of the core is between 1.8 and 1.95. In still other embodiments, the index of refraction of the core is between 1.9 and 1.94. Upon selection of a suitable core 110, the core may then be first coated with lower refractive index material (e.g., 1.4-1.7) to form first optical interference layer 112, followed by coating with a high refractive index material (e.g., 2.0-2.6) to form the second optical interference layer 122. The retroreflective element 100 may be used as a component in a reflective article by affixing the retroreflective element to a substrate or backing In such a construction, a portion of the second optical interference layer 122 is affixed to the substrate by, for example, an adhesive or by embedding the retroreflective elements directly into a major surface of a polymeric substrate. In some embodiments, an auxiliary reflector may be included in the construction of the article.

In some embodiments, the retroreflective elements 100 are used in articles having high retroreflectivity in an exposed-lens construction under wet conditions. In such embodiments, the core 110 of the retroreflective element 100 has an index of refraction typically between about 2.0 and about 2.6. In other embodiments, the index of refraction of the core is between 2.3 and 2.6. In still other embodiments, the index of refraction of the core is between 2.4 and 2.55. The core 110 is first coated with a lower refractive index material (e.g., 1.4.-1.9) to form the first optical interference layer 112, and then coated with a higher refractive index material (e.g., 2.0-2.6) to provide a second optical interference layer 122. The resulting retroreflective element 100 may be used as a component of a reflective article with the retroreflective element 100 affixed to a substrate or backing. In such a construction, the retroreflective element is affixed to the substrate with second optical interference layer 122 embedded, for example, in a polymeric binder, or adhesive. In some embodiments, an auxiliary reflector may be included in the construction of the article.

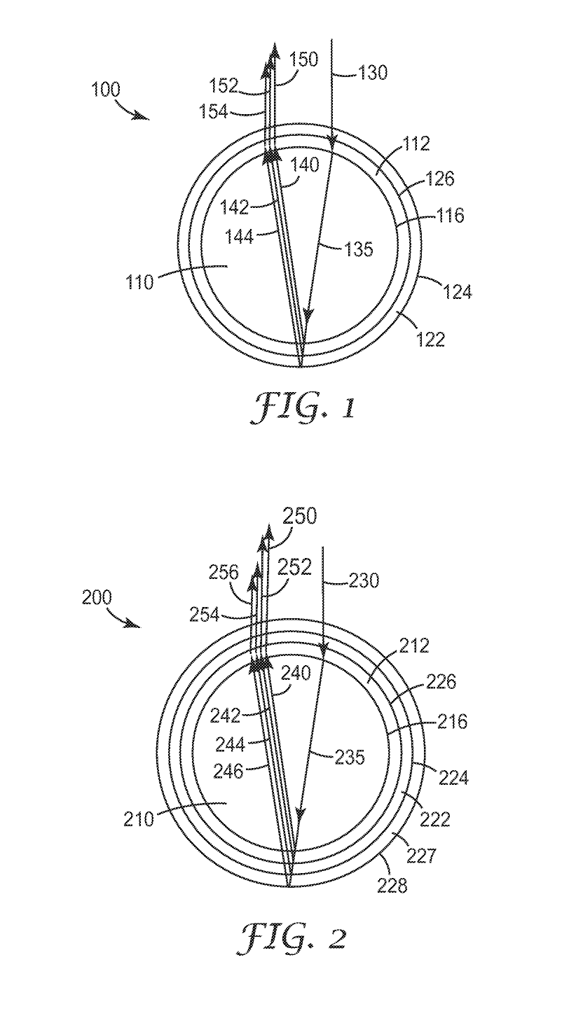

In other embodiments, retroreflective elements comprising beads supporting more than two complete concentric optical interference layers are provided. Referring to FIG. 2, another embodiment of a retroreflective element is shown and will now be described. The retroreflective element 200 includes a transparent substantially spherical core 210 having thereon a first optical interference layer 212. Core 210 contacts first optical interference layer 212 at first interface 216. Second concentric optical interference layer 222 overlies the first concentric optical interference layer 212. Layer 222 has an interior surface that contacts the exterior or outermost surface of first layer 212, forming a second interface 226. The retroreflective element 200 also includes a third optical interference layer 227 which contacts the outermost surface of the second optical interference layer 222 at third interface 224. The third optical interference layer includes an exterior surface which forms the outermost surface of the retroreflective element 200 and forms a fourth interface 228. The first, second and third optical interference layers 212, 222 and 227 are substantially uniform in thickness and concentric with the spherical core 210.

Light is reflected at the interfaces between the materials used in the retroreflective element 200, provided that the different materials have sufficiently different refractive indexes (e.g., having a difference in refractive indexes of at least about 0.1). A sufficient difference in the refractive indexes of the core 210 and first optical interference layer 212 gives rise to a first reflection at first interface 216. Similarly, a sufficient difference in the refractive indexes of first optical interference layer 212 and second optical interference layer 222 gives rise to a second reflection at second interface 226. A sufficient difference in the refractive indexes of second optical interference layer 222 and third optical interference layer 227 gives rise to a third reflection at third interface 224. A sufficient difference in the refractive indexes of third optical interference layer 227 and any background medium (e.g., vacuum, gas, liquid, solid) contacting third optical interference layer 227 gives rise to a fourth reflection at fourth interface 228 of the retroreflective element 200. Selection of the thicknesses and refractive indexes of the optical interference layers 212, 222 and 227 results in reflections and interference effects that provide a retroreflected light that enhances the visibility of an article that includes the retroreflective element 200 as a part thereof. In some embodiments, under white light illumination, the four reflections may destructively interfere with each other for certain wavelengths, resulting in retrochromism wherein the retroreflected light is of a different color from that which would otherwise be observed in the absence of such interference.

Referring again to FIG. 2, an incident beam of light 230 is shown as being directed at retroreflective element 200. Light 230 is shown as being largely transmitted through third optical interference layer 227, second optical interference layer 222 and first optical interference layer 212 before it enters core 210. However, portions of the incident light 230 may be reflected at fourth interface 228, at third interface 224, at second interface 226 or at first interface 216. The portion of the light 230 that enters core 210, is focused by refraction onto the opposite side of the core 210. The refracted light 235 encounters first interface 216 at the back of core 210, some of refracted light 235 is reflected back as reflected light 240 towards the front of the retroreflective element 200 where it ultimately emerges from the element as retroreflected light 250 in a direction that is substantially anti-parallel to incident light 230. Another portion of the focused light passes through optical interference layer 212 and is reflected back at second interface 226 as reflected light 242. Reflected light 242 emerges from the retroreflective element as retroreflected light 252 which travels in a direction that is substantially anti-parallel to incident light 230. Still another portion of the focused light passes through first and second optical interference layers 212 and 222 and is reflected back at third interface 224 as reflected light 244 which ultimately emerges from the retroreflective element 200 as retroreflected light 254. Still another portion of the focused light passes through first, second and third optical interference layers 212, 222 and 227 and is reflected back at fourth interface 228 as reflected light 246 which ultimately emerges from the retroreflective element 200 as retroreflected light 256. The exterior surface of optical interference layer 227 forms a fourth interface 228 with the medium in which the retroreflective element 200 is disposed (e.g., gas, liquid, solid, or vacuum). A portion of incident light is not reflected but passes entirely through the retroreflective element 200.

Interference between reflected light 240, 242, 244, 246 and in turn retroreflected light 250, 252, 254, 256 may give rise to a change in color of the retroreflected light, with respect to the incident light (for example incident white light). For example, subtraction of wavelengths from the center of the spectrum of incident white light results in retroreflected light with a red-violet hue (i.e., retrochromism). Slightly thicker optical interference layers subtract longer wavelengths, resulting in, for example, green or blue-green hues. When incorporated in an article, a plurality of retroreflective elements 200 can provide retrochromic properties that enhance the appearance of the article by providing a covert color, design, message or the like. A retrochromic effect can be obtained by manufacturing the retroreflective element 200 with optical interference layers 212, 222 and 227 of different materials and by selecting the thicknesses and refractive indexes of those materials so that the aforementioned retroreflected light 250, 252, 254, 256 destructively interfere with each other. As a result, the retroreflective element 200, when viewed in a retroreflective mode, provides retroreflected light of a different color from that which would otherwise be observed in the absence destructive interference.

In other embodiments, the proper selection of materials, thicknesses and refractive indexes for the optical interference layers 212, 222, 227, retroreflective element 200 can provide retroreflected light 250, 252, 254, 256 that is brighter (e.g., has a higher coefficient of retroreflection (Ra)) than retroreflected light from uncoated beads, for example. When incorporated in an article, a plurality of retroreflective elements 200 provide retroreflective properties that enhance the visibility of the article.

Constructive interference between reflected light 240, 242, 244, 246 and in turn retroreflected light 250, 252, 254, 256 gives rise to unexpected increases in the brightness or intensity of the retroreflected light. In some embodiments, coating thicknesses for the three optical interference layers can be optimized to provide maximum retroreflectivity when the layers are alternating layers of silica/titania/silica and the core comprises a glass bead having a diameter measuring from about 30 μm to about 90 μm and index of refraction of approximately 1.93. In such embodiments, a first optical interference layer 212 of silica having a thickness between about 95 nm and 120 nm, and typically about 110 nm, a second optical interference layer 222 of titania having a thickness between about 45 nm and 80 nm and typically about 60 nm, and a third optical interference layer 227 of silica having a thickness between about 70 nm and 115 nm, and typically about 100 nm, has provided significantly enhanced coefficient of retroreflection (Ra) when the retroreflective elements are partially embedded as a monolayer in acrylate adhesive.

Reflection at an interface between materials is dependent on the difference in the refractive indexes of the two materials. Materials for the cores and the optical interference layers may be selected from any of a variety of materials, as described herein. The selected materials may comprise either high or low refractive index materials, as long as a sufficient difference in the refractive indexes is maintained between adjacent materials (e.g., core/layer 212; layer 212/layer 222; layer 222/layer 227) and as long as the core provides the desired refraction. The difference in refractive indexes of core 210 and first optical interference layer 212, and the difference in refractive indexes of first optical interference layer 212 and second optical interference layer 222, and the difference between the refractive indexes of second optical interference layer 222 and third optical interference layer 227, and the difference between the refractive indexes of third optical interference layer 227 and the medium against which the back side of retroreflective element 200 is intended to be placed should each be at least about 0.1. In some embodiments, each of the differences between the adjacent layers is at least about 0.2. In other embodiments, the differences are at least about 0.3, and in still other embodiments, the differences are at least about 0.5. The refractive index of optical interference layer 212 may be either greater than or less than the refractive index of core 210. In some embodiments, the choice of refractive index, and the corresponding choice of materials used, will be determined by the choice of the medium that contacts the exterior surface of the retroreflective element 200 to form third interface 224 where reflection is intended to occur.

As described above, for completely concentrically coated retroreflective elements with a front surface surrounded by air and a rear surface surrounded by (e.g., embedded in) a medium having a refractive index of about 1.55, such as a polymer binder, and illuminated with white light, the photopically weighted net intensity of reflected light, to the extent that it is determined by the sequence of transmission and reflection events for exactly antiparallel rays of retroreflected light as they enter and leave the retroreflective element, can vary dramatically with coating thickness or thicknesses, for a given desirable set of coating materials and refractive index values. The photopically weighted net intensity of reflected light produced by the four interfaces established by three coating layers (for example, of amorphous silica, followed by amorphous titania, followed by amorphous silica, on a 1.93 refractive index bead core) can vary by a factor of at least four. For some choices of coatings and thicknesses, the photopically weighted net intensity of reflected light can be significantly reduced versus an uncoated bead.

Suitable materials and coatings for the foregoing optical interference layers include those materials and structures that are partially reflective of incident visible light while also permitting at least a portion of the incident light to be transmitted through the material so that the phenomenon of retroreflectivity, as described herein, can occur. In some embodiments, inorganic materials are used to provide transparent coatings that tend to make bright, highly retroreflective articles. Included among the foregoing inorganic materials are inorganic oxides such as TiO₂ (refractive index of 2.2-2.7) and SiO₂ (refractive index of 1.4-1.5) and inorganic sulfides such as ZnS (refractive index of 2.2). The foregoing materials can be applied using any of a variety of techniques. Other suitable materials having a relatively high refractive index include CdS, CeO₂, ZrO₂, Bi₂O₃, ZnSe, WO₃, PbO, ZnO, Ta₂O₅, and others known to those skilled in the art. Other low refractive index materials suitable for use in the present invention include Al₂O₃, B₂O₃, AlF₃, MgO, CaF₂, CeF₃, LiF, MgF₂ and Na₃AlF₆.

Where the retroreflective elements of the invention are to be used in an environment where water insolubility is not needed, other materials may be used such as, for example, sodium chloride (NaCl). Additionally, it is within the scope of the invention to concentrically coat the bead core of the retroreflective element with multiple layers wherein at least one of the layers is an organic coating.

In order to obtain a desired level of retroreflectivity, the core 210 may be selected to have a relatively high index of refraction. In embodiments, the index of refraction of the core is greater than about 1.5. In other embodiments, the index of refraction of the core is between about 1.55 and about 2.0. In some embodiments, the core 210 may be first coated with low refractive index material (e.g., 1.4-1.7) to form first optical interference layer 212, followed by coating with a high refractive index material (e.g., 2.0-2.6) to form the second optical interference layer 222. Thereafter, the third optical interference layer 227 may be coated over the second optical interference layer using a low refractive index material (e.g., 1.4-1.7). The retroreflective element 200 may be used as a component in a reflective article by affixing the retroreflective element to a substrate or backing. In such a construction, third optical interference layer 227 is affixed to the substrate by, for example, a polymeric adhesive or binder. In some embodiments of the aforementioned articles, the binder itself may be pigmented with diffuse-scattering or specular pigment that enhances the reflective properties and the retroreflectivity of the article.

In some embodiments, the retroreflective elements 200 are used in articles having high retroreflectivity in an exposed-lens construction under dry conditions. In such embodiments, the core 210 of the retroreflective element 200 has an index of refraction typically between about 1.5 and about 2.1. Typically, when the entry medium is air, the index of refraction of the core 210 is between about 1.5 and 2.1. In other embodiments, the index of refraction of the core 210 is between about 1.7 and about 2.0. In other embodiments, the index of refraction of the core 210 is between 1.8 and 1.95. In other embodiments, the index of refraction of the core 210 is between 1.9 and 1.94. The core 210 is first coated with high refractive index material (e.g., 2.0-2.6) to form the first optical interference layer 212, and then coated with a low refractive index material (e.g., 1.4-1.7) to provide a second optical interference layer 222. Thereafter, the third optical interference layer 227 may be coated over the second optical interference layer using a high refractive index material (e.g., 2.0-2.6). The resulting retroreflective element 200 may be used as a component of a reflective article with the retroreflective element 200 affixed to a substrate or backing In such a construction, the retroreflective element is affixed to the substrate with third optical interference layer 227 partially embedded, for example, in an adhesive or by partially embedding the retroreflective element directly in a major surface of a polymeric substrate. In some embodiments, the adhesive or the substrate itself may be pigmented with diffuse-scattering or specular pigment that enhances the retroreflectivity of the article.

Security laminates and articles comprising the retroreflective elements described herein can be made to provide retroreflective patterns when viewed in a retroreflective mode. As used herein, a “pattern” is defined by and composed of a plurality of regions. In some embodiments of the invention, the coated retroreflective elements are arranged in regions which are each discernible if viewed in both retroreflective and other modes. In other embodiments of the invention, the coated retroreflective elements are arranged in regions which are each discernible primarily when viewed only in retroreflective mode. A “retroreflective pattern” is a pattern that comprises two or more regions of different retroreflective brightness or different retroreflective color or both. For example, two regions of a retroreflective pattern may both be retroreflective, but exhibit two different levels of retroreflective brightness, the retroreflective color of the two regions being the same or different, including either or both being white optionally. As another example, one of the two or more regions of a retroreflective pattern may be retroreflective while the other is not. When a retroreflective pattern is not easily discernable under ambient lighting, the retroreflective pattern is a “covert” retroreflective pattern. When a region of a retroreflective pattern exhibits a different color when viewed in retroreflective mode versus when viewed in ambient-lit mode (e.g., non-directional lighting), the region is retrochromic. When a retroreflective pattern includes two or more retroreflective regions, and at least one of them is retrochromic, the retroreflective pattern is a retrochromic pattern.

Retrochromic patterns can comprise one or more regions that are discernible only when viewed in retroreflective mode. Such retrochromic patterns are referred to as being “covert” patterns. In security laminates and articles, the inclusion of covert features or patterns are useful for any of a variety of reasons. In some embodiments, covert patterns are viewable in a retroreflective mode to verify the authenticity of an article. In aspects of such embodiments, the covert patterns are provided so as to present an image or design that is readily identifiable in the retroreflective mode due to, for example, a high level of contrast between the image or design and its background such as by the selection of one retroreflective color for the covert image and a second contrasting color for the background of the image.

Retroreflective patterns, including those that are retrochromic, may be of any size and/or shape (e.g., substantially one, two, or three dimensional) and may be provided in geometric shapes such as, for example, circle(s), line(s) (e.g., wavy, straight or curved), polygon(s) (e.g., triangle(s), square(s), rectangle(s)), polyhedron(s) (e.g., cube, tetrahedron, pyramid, sphere), or other indicia such as one or more alphanumeric character(s) (e.g., letter(s), number(s), trademark(s), logo(s), official seal(s)), and/or graphics. In some embodiments, retroreflective patterns are provided that are microscopic in size in that the patterns require magnification or other viewing aids to discern them. Larger retroreflective patterns are also useful, and it is within the scope of the present invention to provide microscopic retroreflective patterns within larger retroreflective patterns.

Retroreflective patterns are formed utilizing the retroreflective elements described herein, and optionally including other retroreflective elements such as, for example, those described in U.S. Pat. No. 7,036,944 (Budd et al.); and/or retroreflective elements as described in U.S. Pat. Nos. 2,326,634 (Gebhard et al.), and U.S. Pat. No. 5,620,775 (LaPerre), the disclosures of which are incorporated herein by reference thereto.

When the retroreflective elements of the invention are incorporated into an article, the construction of the retroreflective elements can influence whether the article is highly retroreflective as well as whether the article, when viewed in the retroreflective mode, also exhibits covert color. For retroreflective elements coated with silica and/or titania, coating thicknesses of the metal oxide layers can influence the retroreflective characteristics of the finished article. For example, retroreflective elements comprising two complete concentric optical interference layers coated on a 1.9 RI glass core with the first optical interference layer being silica of a thickness of about 110 nm and the second optical interference layer being titania, can produce significant covert color when the second optical interference layer of titania is at a coated thickness within the range from 100 nm to 215 nm. Where the titania layer is less than 100 nm, little or no covert color is observed. These observations apply whether the retroreflective elements are adhered to a polymer backing or whether they are observed in a glass vial with “air” adjacent the entire outer surface of the retroreflective element. Retroreflective elements comprising three complete concentric optical interference layers coated on a 1.9 RI glass core with the first optical interference layer being silica of a thickness of about 110 nm and the second optical interference layer being titania of a thickness of about 60 nm, and the third optical interference layer being silica can produce significant covert color when the third optical interference layer of silica is coated to have a thickness within the range from 50 nm to 75 nm as well as from 95 nm to 120 nm when the retroreflective elements are observed in a glass vial. Little or no covert color is observed for coating thicknesses within the rage from 0-50 or 75-95 nm. When the retroreflective elements are adhered to a polymer backing, covert color is observed for retroreflective elements having a third optical interference layer of silica having a thickness within the range from 30 nm to 120 nm. It will be appreciated that other materials and constructions of retroreflective elements and articles comprising such retroreflective elements will also provide color or enhanced retroreflective brightness in addition to the foregoing constructions. All such embodiments are considered within the scope of the invention.

In some embodiments of the present invention, at least one viewable region may be contained in one or more interior cavities of a substrate. Referring to FIG. 3, article 300 comprises substrate 310 having two viewable interior regions 340 and 342. Interior region 340 contains retroreflective elements 330. In some embodiments, the retroreflective elements 330 exhibit a first retroreflective brightness or color. Interior region 342 contains other retroreflective elements 332 that, in some embodiments, exhibit a second retroreflective brightness or color. In some embodiments, one region (e.g., region 340) may exhibit a first color in a retrochromic effect, as described herein, while the other region (e.g., region 342) exhibits an enhanced retroreflective brightness. In other embodiments, both of the regions 340 and 342 exhibit enhanced retroflective brightness. In still other embodiments, retroreflective elements 330 and retroreflective elements 332 are a mixture of retroreflective elements with different constructions so that a portion of the retroreflective elements in each of the regions 340 and 342 exhibit enhanced retroreflective brightness while a portion of the retroreflective elements in each regions provide retroreflective color. Other variations will be apparent to those skilled in the art. Moreover, it will be understood that the two regions 340 and 342 are intended to be exemplary, and the present invention is not limited in any manner by the number of retroreflective or retrochromic regions in an article.

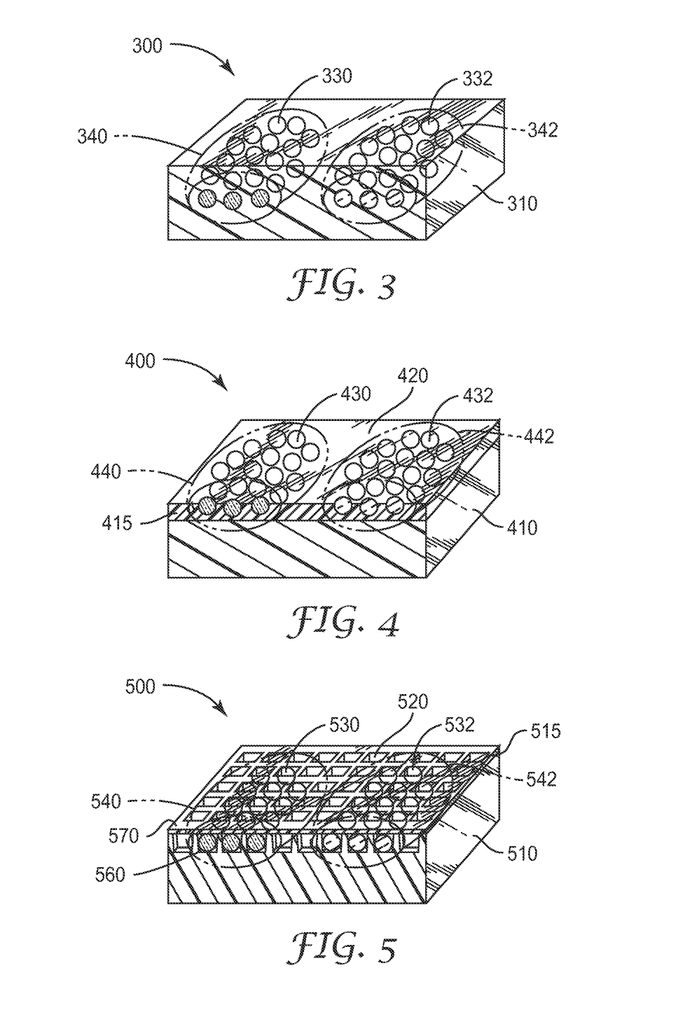

In some embodiments of the present invention, one or more viewable retroreflective regions are combined in an article to form a retroreflective layer. The retroreflective layer may be affixed to a surface of a substrate, either as, for example, a layer of retroreflective elements that have been partially embedded (e.g., by heat and/or pressure) into the surface of the substrate, or as, for example, a coating comprising retroreflective elements and a binder material. An exemplary embodiment is shown in FIG. 4 wherein article 400 includes substrate 410, and retroreflective layer 415 having viewable regions 440 and 442. Retroreflective layer 415 comprises retroreflective elements 430 and 432 affixed within binder 420 with viewable regions 440 and 442. In some embodiments, the regions 440 and 442 are retrochromic and exhibit first and second retroreflective colors, respectively. In some embodiments, one region (e.g., region 440) may exhibit a first color in a retrochromic effect, as described herein, while the other region (e.g., region 442) exhibits an enhanced retroreflective brightness. In other embodiments, both of the regions 440 and 442 exhibit enhanced retroflective brightness. In still other embodiments, retroreflective elements 430 and 432 are a mixture of retroreflective elements with different constructions so that a portion of the retroreflective elements in each of the regions 440 and 442 exhibit enhanced retroreflective brightness while a portion of the retroreflective elements in each region provide a retroreflective color.

Referring to FIG. 5, article 500 includes substrate 510 having a topographical surface 515 with two viewable regions 540 and 542, and having an array of wells 520. Some of wells 520 contain retroreflective elements 530 and 532. Wells 520 may optionally contain a liquid 560. An optional cover layer 570 is affixed to the edges of the wells. The cover layer 570 may be constructed to provide a hermetic seal.

In some embodiments of the invention, the retroreflective elements of the invention provide a retroreflective pattern having at least one identifying mark. Exemplary identifying marks include trademarks, brand names, a manufacturer's name, a government seal or the like.

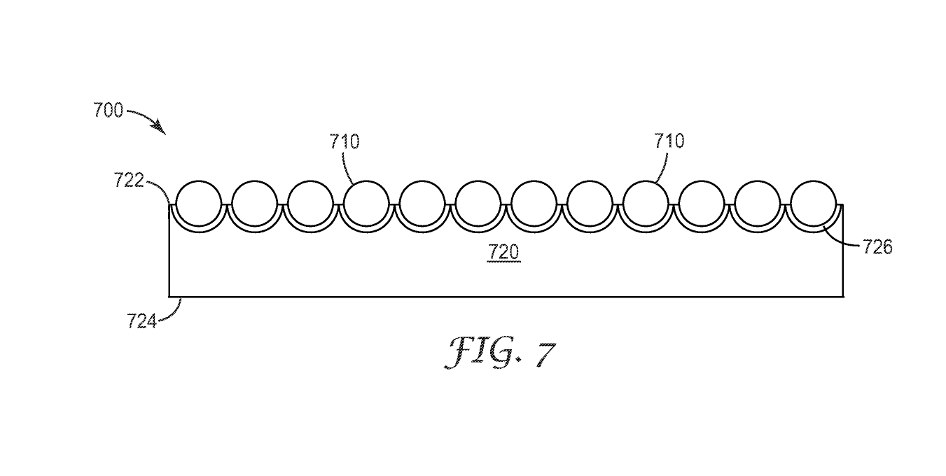

Referring to FIG. 7, a cross-sectional view of a retroreflective security laminate 700 according to an embodiment of the invention is shown and will now be described.

The laminate 700 includes a base sheet or first substrate 720 as a bead-bond layer having a first major surface 722 and a second major surface 724. A plurality of retroreflective elements 710 are affixed to and embedded in the first substrate 720 along the first major surface 722. The retroreflective elements 710 are representative of those shown and described with reference to FIGS. 1 and 2. Additionally, the laminate 700 may include alternative retroreflective elements having, for example, only one optical interference layer or having no optical interference layer at all. In some embodiments, the first substrate 720 comprises a polymer. An optional reflective coating 726 is included in the construction of the article 700 as an auxiliary reflector.

In some embodiments, the polymer of first substrate 720 may be, for example, a thermosetting polymer or a partially crosslinked polymer, wherein the polymer is crosslinked along the first major surface 722 but not along the second major surface 724 or is crosslinked in a gradient wherein the first substrate 720 is more extensively crosslinked along the first major surface 722 than along the second major surface 724. In other embodiments, the first substrate 720 comprises a cross-linked adhesive, with a portion of each retroreflective element 710 embedded within the adhesive. The adhesive may be a thermoset adhesive including adhesive selected from the group consisting of moisture activated adhesives, light activated adhesives, radiation activated adhesives, or combinations of two or more of the foregoing. In some embodiments, the thermoset adhesive may be derived from a hot melt adhesive selected from the group consisting of glues, urethanes, epoxies, aminoplasts and combinations of two or more of the foregoing.

Silane coupling agent or a similar surface modification technique may be used to facilitate or enhance bonding between the retroreflective elements 710 and the first major surface 722 of the first substrate 720. In some embodiments, at least a portion of the plurality of retroreflective elements 710 exhibit enhanced retroreflective brightness. At least a portion of the retroreflective elements 710 exhibit retroreflective color with enhanced retroreflective brightness.

The second major surface 724 of the first substrate 720 may be coated with an adhesive (not shown) to facilitate lamination of the article 700 to a second substrate to provide a security article such as a title document, a stock certificate, a credit card, and/or a debit card, for example. In some embodiments, the first substrate 700 comprises a thermoplastic material at least along the second major surface 724 which can be heated and laminated to a second substrate. The second major surface 724 may bear data in the form of printed indicia (not shown) such as an image or a name, number, or the like. Alternatively, the data may be included on the surface of a second substrate. When the first substrate 720 is laminated to a second substrate the printed indicia is covered by the first substrate 720 but is visible therethrough (e.g., the laminate 700 is transparent). In this manner, the printed indicia can provide security information that, for example, identifies the owner of the article. Moreover, the indicia can be provided in a form that will readily distort if an attempt at tampering takes place and the laminate 700 is removed from the second substrate.

In some embodiments, an additional security layer can be located between the second major surface 724 and the adhesive used to bond the laminate 700 to the document of value. The additional security layer may consist of security printing (e.g., microtext, UV-visible print, color-shifting ink and the like), a transparent security film such as hologram or Kinegram foil, a tamper-indicating layer, a color-shifting film, or other security features known to those skilled in the art. The additional security layer may cover the entire second major surface 724, or it may cover only a portion of the surface 724. For example, in some embodiments, the additional feature may be in registry with side portions of the laminate 700 so that the additional security feature is in only a specified region of the surface.

Further, retroreflective security laminates such as the laminate 700 can be affixed to another substrate to provide any of a variety of security articles (e.g., an item of legal, governmental, and/or financial importance). Exemplary security laminates include validation stickers for vehicle license plates, security films for drivers' licenses, and the like. Security articles include items such as title documents (e.g., to a home or car), stock certificates, financial instruments (e.g., a loan contract), certain types of tickets (e.g., an airline ticket or a lottery ticket), checks, reports, financial cards (e.g., credit card or a debit card), identity cards, currency, passports, and the like. Security laminates of the present invention may also be affixed to other items such as tamper-indicating seals for reclosable containers (e.g., liquor bottles, medication bottles).

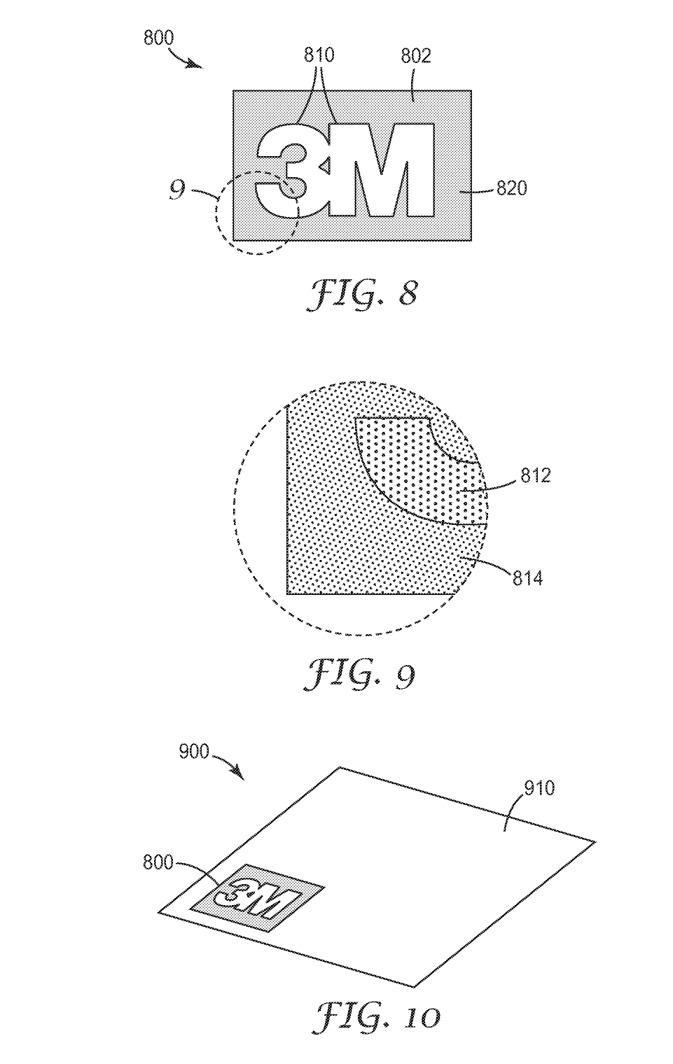

In some embodiments, similar but contrasting retroreflective elements can be arranged in patterns embedded in a bead-bond to provide a laminate with contrasting covert colors as a security feature. Referring to FIGS. 8 and 9, a surface of a security laminate 800 is depicted as would be seen by an observer viewing the laminate 800 in a retroreflective mode. The laminate 800 of FIG. 8 is rectangular in shape but could be provided in any other size or shape. Retroreflective pattern 810 is visible in a retroreflective viewing mode and is provided in the form of a brand name or logo. Pattern 810 is comprised of a plurality of “image retroreflective elements” 812 affixed to a major surface 802 of the laminate 800. At least a portion of the image retroreflective elements 812 are representative of those shown and described with reference to FIGS. 1 and 2. The image retroreflective elements 812 are manufactured to provide a first retroreflective color when viewed in the retroreflective mode. It will be appreciated that the pattern 810 can comprise a collection or assembly of smaller patterns or designs. Pattern 810 is positioned on the surface of the laminate 800 within a background field 820 comprised of “matrix retroreflective elements” 814 to provide a second uniform retroreflective color. While the pattern 810 is centered within the background field 820 of FIG. 8, it will be appreciated that other embodiments are contemplated wherein the pattern is in registration with the sides or edges of the surface 802. At least a portion of the matrix retroreflective elements 814 may be representative of those shown and described with reference to FIGS. 1 and 2. In some embodiments, the background field 820 may comprise other reflective materials and/or retroreflective elements, and more than one retroreflective color can be provided. Although pattern 810 is depicted as a logo, it will be appreciated that any of a variety of patterns may be selected for a security laminate of similar construction. In some embodiments, pattern 810 and the retroreflective color of the background 820 are not otherwise visible to an observer under ordinary or diffuse lighting conditions. In other words, the surface 802 of laminate 800 appears to be uniformly colored or uncolored, and typically transparent, when viewed in diffuse lighting.

Laminate 800 may be affixed to a second substrate as shown in FIG. 9 to provide a security article, as represented by article 900 in FIG. 10. The laminate 800 is as previously described but is laminated to major surface 910 of article 900 which may include printed indicia thereon and/or a layer of holographic foil, for example. In some embodiments, the surface 910 may include a fragile layer and/or personalization data (not shown), such as is described in U.S. patent application Ser. No. 09/846,632 (Publication No. 2002/0163179 A1) the disclosure of which is incorporated herein by reference thereto. In some embodiments, the personalization data is printed on a fragile layer. Personalization data may comprise an image (e.g., a logo or a photo), printed indicia (e.g., a name or identification number) or the like. In the depicted embodiment, article 800 may be laminated to the surface 910 over the personalization data. Where the beadbond layer of laminate 800 is transparent under diffuse lighting, personalization data positioned under the article 800 on surface 910 is visible to authenticate the article 900 or to confirm the identity of the person in possession of the article. For example, a laminate 800 can be provided in which the retroreflective elements are printed only in the region that would cover some or all of the personalization data of a card or passport while the remainder of the laminate would consist of other security features such as a diffractive optically variable image device (DOVID), a hologram, color shifting film, or the like. In some embodiments, various security features can be integrated in some way to provide layered security.

In the event of tampering that involved an attempt to alter the personalization data, the laminate 800 would have to be at least partially removed from the surface 910 and would result in damage to the personalization data. The damage to the data would be apparent and would be indicative of tampering. Additional security features are provided by the retroreflective image 810 and retroreflective background 820, described above. When viewed in retroreflective mode, the image 810 can be used to verify the authenticity of the article 900.

Designs, patterns and the like comprised of the retroreflective elements described herein may be made according to any of a variety of processes. In some embodiments, a printing process may be used in which the retroreflective elements are mixed in a transparent ink and the retroreflective element/ink mixture is laid down (e.g., printed) as an image or pattern. In such embodiments, the retroreflective element/ink mixture may be printed onto a specific region of substrate, and one or more such mixtures may be printed onto a single substrate for inclusion in a single security laminate. Each retroreflective element/ink mixture may be printed onto a substrate to define a region, and one or more regions may be present on the same substrate to form a retroreflective pattern or design for a security laminate. Suitable printing techniques include but are not limited to screen-printing, offset printing, or coating over a customized mask.

In other embodiments, a printing process may be used in which an ink is printed to first generate a tacky surface in a specific location followed by bead placement. The ink could be a solvent, a solution containing a thermoplastic polymer, a pre-polymer or UV curable ink, a latex solution, ink jet based ink, or the like. The ink can be placed using X-Y printing, ink jet printing, stamping, screen printing, offset printing, intaglio printing, lithography, or similar printing processes known in the art. Beads are then exposed to the entire substrate surface, preferentially sticking only to the inked region, providing a retroreflective pattern only where the printing was performed.

In some embodiments, a heated printing process could be used on specific regions of a thermoplastic substrate so that regions of the surface become tacky from heating. Any of a number of known heating techniques would be suitable including the use of infrared (IR) lamps, direct contact of the substrate with a heated surface, or a mask under a hot source. The use of heat allows for bead placement in specific regions (e.g., the regions exposed to heat), to generate specific retroreflective patterns.

In some embodiments, an inherently tacky substrate such as a pressure sensitive adhesive can be printed by using a mask and flood-coating operation.

In some embodiments of this invention, multiple printing steps with retroreflective elements of different constructions (and different retroreflective color) are employed to provide retroreflective patterns with multiple colors.

For any of these printing techniques, post-print processing techniques such a radiation treatment, heating, or UV curing could follow the bead placement to secure the beads to the substrate in an appropriate manner. For example, if the beads are bonded to a thermoplastic substrate, putting the article through a heat cycle (e.g., hot-roll laminator or a heated convection oven) could sink the beads into the substrate, generating better bead/bead-bond adhesion.

In another method, if the un-printed surface of the substrate can be made tacky, the entire surface can be flood-coated by retrochromic elements of a different retroreflective color. This tackiness could be made by heating a thermoplastic substrate or applying another printed adhesive. The beads would adhere to the tacky un-printed regions of the substrate. This would allow for the generation of a retroreflective matrix around the retroreflective pattern, providing a covert security feature. Instead of coating the entire surface, a mask can be used to deposit the retroreflective elements on specific regions. If multiple masks with different retrochromic beads are used, this process could be used to generate a pattern with the matrix retroreflective elements.

In some embodiments, the ink is provided in a different color than the color(s) provided by the retroreflective elements to achieve a distinctive look when alternating between ambient-lit viewing mode and retroreflective viewing mode. In other embodiments, a colored ink can be selected to have a color similar or identical to the covert color(s) provided by the retroreflective elements of the invention to produce a document in which the color of the ink background is enhanced significantly when the article is viewed in the retroreflective mode. In other embodiments, inks containing retroreflective elements providing differing levels of enhanced retroreflective brightness can be used to create patterns having regions of differing retroreflective brightness.

In the manufacture of a security laminate, retroreflective elements may be coated along a first major surface of a substrate, while the opposite side or second major surface of the substrate (e.g., the document side) is kept retroreflective element-free. Proper adhesion of the retroreflective elements to the substrate may require that the retroreflective elements be at least partially sunken in an adhesive or into the substrate itself to a depth between about 20% and 70% of the diameter of the retroreflective elements. In some embodiments, the retroreflective elements are sunken to a depth of between about 30% and about 60% of the retroreflective element diameter. The coated retroreflective elements may be sunken into the adhesive or substrate by compressing the retroreflective element/substrate composite between a pair of rollers at an elevated temperature.

Polymeric films suitable as substrates include without limitation modified polyethylene (PE) materials such as ethylene vinyl acetate (EVA) or ethylene acrylic acid (EAA) copolymers or maleic-anhydride grafted polymers. Suitable EVA materials are commercially available such as those available under the trade designation “Fusabond” from E. I. du Pont de Nemours and Company, and in particular, the material designated as Fusabond MC190D. Suitable EAA copolymers are commercially available such as the copolymers available under the trade designation “Primacor” from the Dow Chemical Company and particularly those available under the designation Primacor 3340. In some embodiments, polymeric substrates (e.g., EVA or EAA copolymer) may be provided as extruded films manufacture using a cast film extrusion process, for example.

It will be appreciated that any of a variety of polymers may be used as a substrate in the present invention. Suitable polymers include thermoplastic polymers as well as thermosetting polymers. Further examples of suitable thermoplastics include amorphous thermoplastics such as polymethylmethacrylate (PMMA), polystyrene (PS) and polycarbonate (PC), for example. Semi-crystalline thermoplastics may also be used such as polyethylene (PE), polypropylene (PP), polybutylterephthalate (PBT) and polyethyleneterephthalate (PET).

Additional thermoplastics include those selected from the group consisting of acrylonitrile butadiene styrene (ABS), acrylic polymer, celluloid, cellulose acetate, ethylene-vinyl acetate, ethylene vinyl alcohol, fluoroplastics, ionomers, liquid crystal polymer, polyacetal, polyacrylates, polyacrylonitrile, polyamide, polyamide-imide, polyaryletherketone, polybutadiene, polybutylene, polybutylene terephthalate, polyetherimide, polyethersulfone, polysulfone, polyethylenechlorinates, polyimide, polylactic acid, polymethylpentene, polyphenylene oxide, polyphenylene sulfide, polyphthalamide, polypropylene, polystyrene, polysulfone, polyvinyl chloride, polyvinylidene chloride and combinations of two or more of the foregoing.

Examples of thermosetting polymers include those selected from the group consisting of vulcanized rubber, bakelite, phenol formaldehyde resin, urea-formaldehyde melamine resin, polyester resin, epoxy resin, polyimides and combinations of two or more of the foregoing.

In some embodiments, the interface between the beadbond and the retroreflective element may be modified by treating the retroreflective elements or the substrate with a coupling agent such as a silane coupling agent, for example. In such embodiments, the silane moieties will bond with the polymeric substrate and/or the retroreflective elements described herein. Silane moieties are more likely to bond with certain substrates such as an acid-modified polyethylene like that commercially available from DuPont under the trade designation “Bynel 3126.” A suitable silane coupling agent is gamma-aminopropyltriethoxy silane, commercially available through OSi Specialties as “Silquest® A1100.” The use of silane coupling agent may increase the friction between the retroreflective elements during the printing and flood-coating steps. Therefore, it may be necessary to include a flow aide to the retroreflective elements. Examples of suitable particulate flow aides include Cabosil TS530, HiSili 233, and Flo-gard FF L-26-0. Adhesion to the retroreflective elements may be improved through the use of other treatments known to those skilled in the art such as corona treatment or plasma treatment, for example.

As discussed with respect to the substrate 720 of FIG. 7, some embodiments can include a substrate that is a cross-linked polymer with improved resistance to chemical, mechanical or thermal degradation. The polymer substrate includes a “bead side” on which the retroreflective elements are disposed and a “document side” which is adhered or otherwise affixed to a document. The document side can be adhesively laminated to the security document using a suitable adhesive coated, for example, along the document side of the substrate. Cross-linking of the substrate may be accomplished in a known manner such as by radiation curing. In some embodiments, the curing reaction can be limited to the retroreflective element-coated side of the substrate so that that the retroreflective element side is more heavily cross-linked than the document side. Other techniques include the use of a cross-linking agent added to the retroreflective element-side of the substrate in a gradient so that the retroreflective element-side contains more of the agent than the non-retroreflective element side. Subsequent application of a curing technique facilitates the crosslinking of the substrate with more extensive crosslinking on retroreflective element-side. In other embodiments, a thin bead-bond layer (e.g., coated retroreflective elements bonded to an adhesive layer) is cross-linked in its entirety and is subsequently laminated to a substrate with substantially less cross-linking In some embodiments, a security laminate or security article comprising retroreflective elements may be provided with a “floating image” like that described in patent U.S. Pat. No. 6,288,842 (Florczak et al.), the entire disclosure of which is incorporated herein by reference. According to that disclosure, floating images (e.g., images that appear to “float” above or below a sheeting) can be provided by imaging a radiation sensitive material layer positioned behind a layer of retroreflective elements affixed to a substrate. Light impinging on the retroreflective elements is focused onto the radiation sensitive layer to modify the layer and produce an image that appears to float above or below the substrate. The beads and bead-bond layer may contain additive(s) or chemistry to augment this floating image. Additives may include, for example, dyes designed to absorb laser radiation at the desired wavelength.

A protective coating may be applied over the retroreflective elements on the surface of the substrate to protect the substrate and the retroreflective elements from grime, dirt, and weathering. Suitable protective materials are commercially available such as those available under the trade designation “Scotchgard” from 3M Company of St. Paul, Minn.

The construction of retroreflective patterns using the retroreflective elements of the invention are described in the following paragraphs which are applicable to the manufacture of security laminates and articles that incorporate the retroreflective elements described herein. Retroreflective patterns may be formed in a variety of ways. In one exemplary method, a carrier sheet (e.g., a polyethylene film) having a monolayer of partially exposed retroreflective elements is prepared by the method described, for example, in U.S. Pat. No. 4,367,920 (Tung et al.), the disclosure of which is incorporated herein by reference. An adhesive binder material (e.g., a glue, a pressure-sensitive adhesive, or a hot melt adhesive) is applied to the exposed retroreflective elements in an image-wise manner (e.g., by screen printing, ink jet printing, or thermal transfer printing) as described, for example, in U.S. Pat. No. 5,612,119 (Olsen et al.), or U.S. Pat. No. 5,916,399 (Olsen), the disclosures of which are incorporated herein by reference. The imaged adhesive binder is brought into contact with the substrate, whereby the binder becomes affixed to the substrate. The carrier sheet is then stripped off, exposing the retroreflective elements, which remain affixed to the binder. This transfer printing process may be repeated with different retroreflective elements and can lead to retroreflective patterns having, for example, three, four, five, or more regions with distinctive appearances if viewed in retroreflective mode. In some embodiments, one or more of the regions may exhibit retroreflective color when viewed in a retroreflective mode.

In another method, adhesive binder may be applied to a substrate (e.g., like substrate 720 in FIG. 7). The adhesive is applied in an image-wise manner directly to a major surface (e.g., first major surface 722) of the substrate (e.g., heat lamination, pressure lamination, spraying) in a softened or molten condition. The adhesive may thereafter be flood coated with retroreflective elements so that the retroreflective elements adhere to the adhesive. In this process, retroreflective elements are applied liberally over the surface of a substrate, and the substrate may be heated to dry and/or partially cure the adhesive. Following cooling, the coated substrate may be brushed to remove excess retroreflective elements to provide a single layer of retroreflective elements bonded to the top of the substrate.

In embodiments where the applied coating of retroreflective elements includes those that exhibit retroreflective color (e.g., they are retrochromic), a second application of adhesive binder in an image-wise manner followed by flood coating with other retroreflectively colored elements that are different from the retroreflective elements previously adhered to the substrate results in a pattern having two viewable retroreflective regions on the surface of a substrate. Repetition of this process can lead to retroreflective colored patterns having, for example, three, four, five, or more regions with distinctive appearances if viewed in retroreflective mode. An optional protective layer (e.g., a transparent thermoplastic film) may be bonded to (e.g., heat laminated or adhesively bonded) the exposed retroreflective elements. The various regions may exhibit different retroreflective colors which in some embodiments, may vary in their retroreflective brightness, or the like. Those skilled in the art will appreciate that, following placement of the retroreflective elements, the adhesive or substrate may be further treated to solidify and/or dry it. Depending on the nature of the adhesive, it may be exposed to heat or to UV radiation, for example, to polymerize the monomers and oligomers present in the adhesive composition and/or to crosslink the polymer.

In another method, a dispersion of retroreflective elements in a liquid vehicle may be printed onto a topographical surface comprising an array of wells. The dispersion may further comprise a binder material. The liquid, retroreflective elements, and optional binder collect in wells where printed. The liquid may be allowed to evaporate or not, as desired. The printing process may be repeated as many times as desired using retroreflective elements that exhibit retroreflective color or which exhibit a desired retroreflective brightness, each application of retroreflective elements being of a different construction from previously printed retroreflective elements. An optional cover layer may be laminated to the topographical surface thereby sealing the tops of the wells and creating an array of fully enclosed cavities containing retroreflective elements.

For some embodiments, the coated substrate may then go through a bead-sinking process to sink the retroreflective elements into the substrate. Such a bead-sinking processes could include the use of a laminator at an elevated temperature using moderate pressure. Alternatively, the retroreflective element-covered surface could pass through a heated convection oven, where surface energy forces will cause the retroreflective elements to sink further into the bead-bond. The substrate of a security laminate may be at least partially transparent, translucent, and/or opaque. In some embodiments, the substrate is transparent throughout its entirety. The substrate may be homogenous or heterogeneous in composition and typically includes first and second opposed major surfaces. Suitable substrates comprise thermoplastic film (e.g., polyurethane film), metal foil, and/or paper.

In some embodiments of the present invention, an optional adhesive layer is affixed (e.g., adhesively bonded) to the substrate of the laminate. The adhesive layer may also, optionally, contact a release liner (e.g., a polyethylene or silicone coated paper or film). The adhesive layer typically comprises at least one of a hot melt adhesive, a thermoset adhesive, or a pressure-sensitive adhesive. Exemplary hot melt adhesives include thermoplastic hot melt adhesives (e.g., polyesters, polyurethanes, vinyl acetate copolymers, or polyolefins), and thermosettable hot melt adhesives (e.g., moisture activated adhesives, light activated adhesives, radiation activated adhesives, or combinations thereof). Exemplary thermoset adhesives include glues, urethanes, epoxies, and aminoplasts. Exemplary pressure-sensitive adhesives include acrylate copolymers (e.g., a copolymer of isooctyl acrylate and acrylic acid), desirably applied to the substrate as a latex as described in, for example, U.S. Pat. No. 4,630,891 (Li), the disclosure of which is incorporated herein by reference.

The retroreflective elements may be prepared using a fluidized bed of transparent beads and vapor deposition techniques. The processes of depositing vapor phase materials onto a fluidized (i.e., agitated) bed of bead cores is collectively referred to as “vapor deposition processes” in which a concentric layer is deposited on the surface of respective transparent beads from a vapor form. In some embodiments, vapor phase precursor materials are mixed in proximity to the transparent beads and chemically react in situ to deposit a layer of material on the respective surfaces of the transparent beads. In other embodiments, material is presented in vapor form and deposits as a layer on the respective surfaces of the transparent beads with essentially no chemical reaction. Depending upon the deposition process being used, precursor material(s) (in the case of a reaction-based deposition process) or layer material(s) (in the case of a non-reaction-based process), typically in vapor phase, is or are placed in a reactor with transparent bead cores. A vapor phase hydrolysis reaction deposits a concentric optical interference layer (e.g., a layer of metal oxide) onto the surface of a respective core. Such process is sometimes referred to as a chemical vapor deposition (“CVD”) reaction.

In some embodiments, a low temperature, atmospheric pressure chemical vapor deposition (“APCVD”) process is used. Such processes do not require vacuum systems and can provide high coating rates. Hydrolysis-based APCVD (i.e., APCVD wherein water reacts with a reactive precursor) is most desired because of the ability to obtain highly uniform layers at low temperatures, e.g., typically well below 300° C.

The following is an illustrative vapor phase hydrolysis-based reaction:

TiCl₄+2H₂O→TiO₂+4HCl

In the illustrative reaction, water vapor and titanium tetrachloride, taken together, are considered metal oxide precursor materials.

Useful fluidized bed vapor deposition techniques are described, for example, in U.S. Pat. No. 5,673,148 (Morris et al.), the disclosure of which is incorporated herein by reference.

A well-fluidized bed can ensure that uniform layers are formed both for a given particle and for the entire population of particles. In order to form substantially continuous layers covering essentially the entire surfaces of the transparent beads, the transparent beads are suspended in a fluidized bed reactor. Fluidizing typically tends to effectively prevent agglomeration of the transparent beads, achieve uniform mixing of the transparent beads and reaction precursor materials, and provide more uniform reaction conditions, thereby resulting in highly uniform concentric optical interference layers. By agitating the transparent beads, essentially the entire surface of each assembly is exposed during the deposition, and the assembly and reaction precursors or layer material may be well intermixed, so that substantially uniform and complete coating of each bead is achieved.

If using transparent beads that tend to agglomerate, it is desirable to coat the transparent beads with fluidizing aids, e.g., small amounts of fumed silica, precipitated silica, methacrylato chromic chloride having the trade designation “VOLAN” (available from Zaclon, Inc., Cleveland, Ohio). Selection of such aids and of useful amounts thereof may be readily determined by those with ordinary skill in the art.

One technique for getting precursor materials into the vapor phase and adding them to the reactor is to bubble a stream of gas, desirably a non-reactive gas, referred to herein as a carrier gas, through a solution or neat liquid of the precursor material and then into the reactor. Exemplary carrier gases include argon, nitrogen, oxygen, and/or dry air.

Optimum flow rates of carrier gas(es) for a particular application typically depend, at least in part, upon the temperature within the reactor, the temperature of the precursor streams, the degree of assembly agitation within the reactor, and the particular precursors being used, but useful flow rates may be readily determined by routine optimization techniques. Desirably, the flow rate of carrier gas used to transport the precursor materials to the reactor is sufficient to both agitate the transparent beads and transport optimal quantities of precursor materials to the reactor.

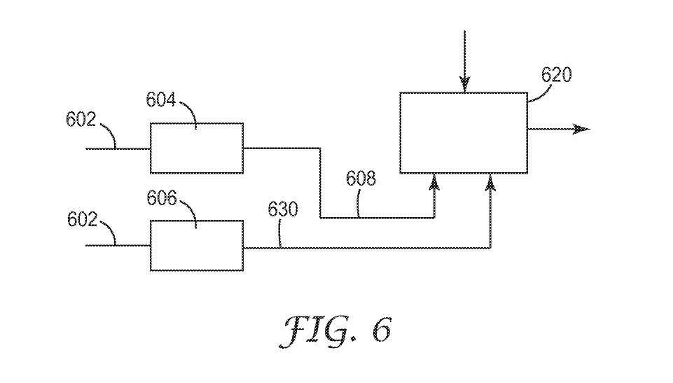

Referring to FIG. 6, a process for making retroreflective elements is shown. Carrier gas 602 is bubbled through water bubbler 604, to produce water vapor-containing precursor stream 608. Carrier gas 602 is also bubbled through titanium tetrachloride bubbler 606, to produce titanium tetrachloride-containing precursor stream 630. Precursor streams 608 and 630 are then transported into heated reactor 620. Uncoated beads or cores are introduced into reactor 620 where the cores attain a coating of titanium oxide. The thickness of the coating may be controlled by monitoring the retroreflective color of the retroreflective elements in the reactor 620. For example, a retrochromic color of bright purple indicates a coating thickness of about 80 nm. The progress of layer deposition may be monitored by viewing the developing retroreflective elements in retroreflective mode, for example, by using a retroviewer (e.g., as described in U.S. Pat. No. 3,767,291 (Johnson) and U.S. Pat. No. 3,832,038 (Johnson), the disclosures of which are incorporated herein by reference) either in situ using a glass-walled reactor or by removal of retroreflective elements from the reactor. Retroviewers useful for viewing retroreflective elements having a retroreflective color and articles containing them are also commercially available, for example, under the trade designation “3M VIEWER” from 3M Company, St. Paul, Minn.

The aforementioned process may be repeated to deposit additional coated layers onto the cores, typically changing the reactant used for each layer. For example, a titanium oxide-coated retroreflective element may subsequently receive a coating of silicon oxide by using silicon tetrachloride as a coating precursor followed by oxidation. Adjustments in the process parameters for each of the coatings may be desired and is within the skill of those practicing in the field. Typically, precursor flow rates are adjusted to provide an adequate deposition rate and to provide a metal oxide layer of desired quality and character. Desirably, flow rates are adjusted such that the ratios of precursor materials present in the reactor chamber promote metal oxide deposition at the surface of the retroreflective elements with minimal formation of discrete, i.e., free floating, metal oxide particles, elsewhere in the chamber. For example, if depositing layers of titania from titanium tetrachloride and water, a ratio of between about eight water molecules per each titanium tetrachloride molecule to one water molecule per two titanium tetrachloride molecule is generally suitable, with about two water molecules of water per titanium tetrachloride molecule being preferred. Under these conditions there is sufficient water to react with most of the titanium tetrachloride and most of the water is adsorbed onto the surface of the retroreflective element. Much higher ratios tend to yield substantial quantities of unabsorbed water that might result in formation of oxide particulates rather than the desired oxide layers.

Desirably, precursor materials have sufficiently high vapor pressures that sufficient quantities of precursor material will be transported to the reactor for the hydrolysis reaction and layer deposition process to proceed at a conveniently fast rate. For instance, precursor materials having relatively higher vapor pressures typically provide faster deposition rates than precursor materials having relatively lower vapor pressures, thereby enabling the use of shorter deposition times. Precursor sources may be cooled to reduce vapor pressure or heated to increase vapor pressure of the material. The latter may necessitate heating of tubing or other means used to transport the precursor material to the reactor, to prevent condensation between the source and the reactor. In many instances, precursor materials will be in the form of neat liquids at room temperature. In some instances, precursor materials may be available as sublimable solids.

Certain desirable precursor materials are capable of forming dense metal oxide coatings via hydrolysis reactions at temperatures below about 300° C., and often below about 200° C., for coating beads. In some embodiments, titanium tetrachloride and/or silicon tetrachloride, and water are used as precursor materials. In addition to water and volatile metal chlorides, other precursor materials include, for example, mixtures of water and at least one of: metal alkoxide(s) (e.g., titanium isopropoxide, silicon ethoxide, zirconium n-propoxide), metal alkyl(s) (e.g., trimethylaluminum, diethylzinc). It may be desirable to utilize several precursors simultaneously in a coating process. However, mutually reactive precursor materials, e.g., TiCl₄ and H₂O, are not mixed prior to being added to the reactor in order to prevent premature reaction within the transport system. Multiple gas streams into the reaction chamber are typically provided.

Vapor deposition processes include hydrolysis based CVD and/or other processes. In such processes, the beads are typically maintained at a temperature suitable to promote effective deposition and formation of the concentric optical interference layer with desired properties on the beads. Increasing the temperature at which the vapor deposition process is conducted typically yields a resultant concentric layer that is denser and retains fewer fugitive unreacted precursors. Sputtering or plasma-assisted chemical vapor deposition processes, if utilized, often require minimal heating of the article being coated, but typically require vacuum systems, and can be difficult to use if coating particulate materials such as small glass beads.

Typically, a deposition process that operates at a temperature low enough not to undesirably degrade the transparent beads should be selected. Deposition of an optical interference layer is achieved using a hydrolysis-based APCVD process at temperatures below about 300° C., and typically below about 200° C. Titania and titania-silica layers deposited from tetrachlorides are easily deposited by APCVD at low temperatures, e.g., between about 120° C. and about 160° C. Silica layers are often deposited at temperatures between about 20° C. and about 100° C.

A dimensionally stable substantially spherical transparent bead may be used as a core in the retroreflective elements of the present invention. Cores may be inorganic, polymeric or other provided that they are substantially transparent to at least one wavelength of visible light. Typically, cores have a diameter of from about 20 to about 500 micrometers. In some embodiments, the diameter ranges from about 50 to about 100 micrometers, although other diameters are possible.

In some embodiments, the core of the coated retroreflective elements are made of an inorganic glass having a refractive index of from about 1.5 to about 2.5 or even higher. In some embodiments, the refractive index ranges from about 1.7 to about 1.9. Cores may also have a lower refractive index value depending on the particular intended application, and the composition of the concentric optical interference layer. For example, a silica glass bead with refractive index as low as about 1.50 may be used as a core because of the low cost and high availability of soda-lime-silica (i.e., window glass). Optionally, cores may further comprise a colorant. Exemplary materials that may be utilized as a core include glasses (e.g., mixtures of metal oxides such as SiO₂, B₂O₃, TiO₂, ZrO₂, Al₂O₃, BaO, SrO, CaO, MgO, K₂O, Na₂O); and solid; transparent, non-vitreous, ceramic particles as described in, for example, U.S. Pat. No. 4,564,556 (Lange) and U.S. Pat. No. 4,758,469 (Lange), the disclosures of which are incorporated herein by reference. Colorants include transition metals, dyes, and/or pigments selected according to their compatibility with the chemical composition of the core, and the manufacturing conditions utilized.

The magnitude of retroreflection may be increased by coating onto the retroreflective element an integral hemispherical reflector as described in, for example, U.S. Pat. No. 2,963,378 (Palmquist et al.), the disclosure of which is incorporated herein by reference.

The following non-limiting examples illustrate specific embodiments of the present invention.

### EXAMPLES

The following standard procedures were employed.

Procedure A: Preparation of Retroreflective Elements

Retroreflective elements with multiple complete concentric optical interference layers were formed by depositing metal oxide (titania or silica) coatings onto transparent bead cores using an atmospheric pressure chemical vapor deposition process (APCVD) similar to that described in U.S. Pat. No. 5,673,148 (Morris et al.), the disclosure of which is incorporated herein by reference thereto. The reactor had an internal diameter of 30 mm. The initial charge of transparent bead cores weighed 60 g. For silica coatings, the reaction temperature was set at 40° C. while titania coatings were deposited using a reaction temperature of 140° C. The desired reaction temperature was controlled by immersing the reactor in a heated oil bath maintained at a constant temperature. The bed of beads was fluidized with a stream of nitrogen gas introduced into the reactor through a glass frit reactor base. Once satisfactory fluidization was achieved, water vapor was introduced into the reactor through the base glass frit using a stream of nitrogen carrier gas passed through a water bubbler. The metal oxide precursor compounds (either SiCl₄ or TiCl₄) were vaporized by passing nitrogen carrier gas through a bubbler containing the neat liquid precursor and introducing the vaporized compounds into the reactor through a glass tube extending downward into the fluidized bead bed.

Multiple coatings were deposited by repeating the procedure for samples of retroreflective elements having previously deposited coatings.

Flow rates of the reactant-laden carrier gases and reaction temperatures for silica and titania coatings are reported in Table 1.

TABLE 1

| | | | | | Extra |
|---|---|---|---|---|---|
| | | | Precursor | Water | Nitrogen |
| | Reaction | | bubbler | bubbler | flow |
| Type of | Temp | | flow rate | flow rate | rate |
| coating | (° C.) | Precursor | (cc/min) | (cc/min) | (cc/min) |
| SiO₂ | 40 | SiCl₄ | 40 | 600 | 500 |
| TiO₂ | 140 | TiCl₄ | 600 | 600 | 500 |

In some instances, samples of different coating thicknesses were made by varying the coating times. This was accomplished by removing a small volume of retroreflective elements from the reactor at different times. Coating rates were determined by fracturing certain concentrically retroreflective elements that had been sampled from the reactor at known coating deposition times and examining the fracture pieces with a scanning electron microscope to directly measure the coating thicknesses. Thereafter, the thicknesses of the concentric coatings were calculated from known coating times and coating rates. A coating rate of ˜2 nm/min was typical for the silica coatings, and a coating rate of ˜5 nm/min was typical for the titania coatings.

Procedure B: Patch Brightness

Measurements of retroreflected brightness include “patch brightness” measurements of the coefficient of retroreflection (Ra) of a layer of retroreflective elements. Clear Patch Brightness as well as White Patch Brightness measurements were made. Clear Patch Brightness results are designated herein as “Ra (CP)” and White Patch Brightness results are designated as “Ra (WP).” In either case, layers of retroreflective elements were made by sprinkling them onto an adhesive tape and placing the construction under a retroluminometer. For Clear Patch Brightness, sample constructions were prepared by partially embedding the retroreflective elements in the adhesive of a transparent tape (3M Scotch 375 Clear Tape) and placing the tape on top of a sheet of paper having a dark (black) background. White Patch Brightness sample constructions were prepared by partially embedding the retroreflective elements in the adhesive of a tape in which the adhesive was pigmented with titanium dioxide to impart a white color. retroreflective elements were typically embedded in the adhesive to <50% of its diameter. For each of the Patch Brightness constructions, the Ra in Cd/m²/lux was determined according to the procedure established in procedure B of ASTM Standard E 809-94a, measured at an entrance angle of −4.0 degrees and an observation angle of 0.2 degrees. The photometer used for those measurements is described in U.S. Defensive Publication No. T987,003. The Patch Brightness readings were taken with light incident on the major surface of the aforementioned constructions that supports the layer of retroreflective elements or elements.

Procedure C: Color Measurements

The retroreflective color or retrochromic effects were quantified by measuring color coordinates using an optical spectrometer (MultiSpec Series System with an MCS UV-NIR spectrometer and 50 watt halogen light source and bifurcated optical fiber probe, commercially available from Tec5 AG, Oberursol, Germany). Concentrically coated retroreflective elements were partially embedded in the adhesive of a commercially available tape (3M Scotch 375 Clear Tape). The embedded retroreflective elements were placed under a fiber optic probe at a distance of ˜5 mm, and spectral measurements were made in the wavelength range 300 nm-1050 nm using a black background. A front surface mirror was used as the reference, and all measurements were normalized. Chromaticity coordinates were calculated from the reflectance spectra using (MultiSpec® Pro software with color module, commercially available from Tec5 AG, Oberursol, Germany). Color coordinates were measured for retroreflective elements made according to certain Comparative Examples and certain Examples, as specified herein. A CIE chromaticity diagram (1931 version) was referenced as well as a standard black body curve. The black body curve passes through white between approximately 4800K and 7500K. The corresponding color coordinates at these temperatures are (0.353, 0.363) and (0.299, 0.317).

Measurements made from retroreflective elements showing little or no visible color in retroreflection lay within 0.01 of the black body radiation curve between 4800K and 7500K. It should be noted that the (x, y) coordinates correspond to the 1964 10 degree field of view modification to the original 1931 coordinates. The CIE chart and black body radiation curves are described in Zukauskas et al., Introduction to Solid State Lighting, John Wiley and Sons (2002); Chapter 2 (Vision, Photometry, and Colorimetry), pp. 7-15.

### Comparative Examples 1-44

The bead cores used in the preparation of Comparative Examples 1-44 are referred to herein as Type I bead cores which were transparent glass beads having a refractive index of about 1.93, an average diameter of about 60 μm, and an approximate composition of 44.2% TiO₂, 29.2% BaO, 12.6% SiO₂, 9% Na₂O, 3% B₂O₃, and 2% K₂O by weight. Comparative Example 1 was an uncoated Type I bead core. Comparative Examples 2-44 were prepared according to the above Procedure A and comprised a single complete concentric interference layer. For Comparative Examples 2-25, the single complete concentric interference layer was silica while Comparative Examples 26-44 had a single complete concentric interference layer of titania. Coating times, calculated coating thicknesses, and retroreflected brightness (Ra) of Clear Patch constructions made with the retroreflective element are reported in Table 2.

TABLE 2

| | | | Estimated | |
|---|---|---|---|---|
| | | Coating | coating | |
| Comparative | Coating | time | thickness | |
| Example | material | (min) | (nm) | Ra (CP) |
| 1 | none | uncoated | uncoated | 7.7 |
| 2 | SiO₂ | 18 | 36 | 9.76 |
| 3 | SiO₂ | 22 | 44 | 10.5 |
| 4 | SiO₂ | 26 | 52 | 11.7 |
| 5 | SiO₂ | 31 | 62 | 12.8 |
| 6 | SiO₂ | 34 | 68 | 13.5 |
| 7 | SiO₂ | 37 | 74 | 14.4 |
| 8 | SiO₂ | 40 | 80 | 15.1 |
| 9 | SiO₂ | 44 | 88 | 16.1 |
| 10 | SiO₂ | 48 | 96 | 17 |
| 11 | SiO₂ | 52 | 104 | 17.5 |
| 12 | SiO₂ | 55 | 110 | 17.1 |
| 13 | SiO₂ | 58 | 116 | 17 |
| 14 | SiO₂ | 61 | 122 | 15.3 |
| 15 | SiO₂ | 63 | 126 | 14.7 |
| 16 | SiO₂ | 65 | 130 | 13.2 |
| 17 | SiO₂ | 67 | 134 | 12.3 |
| 18 | SiO₂ | 69 | 138 | 11.1 |
| 19 | SiO₂ | 71 | 142 | 10.2 |
| 20 | SiO₂ | 73 | 146 | 9.3 |
| 21 | SiO₂ | 76 | 152 | 8.6 |
| 22 | SiO₂ | 78 | 156 | 8.2 |
| 23 | SiO₂ | 81 | 162 | 8.16 |
| 24 | SiO₂ | 84 | 168 | 8.55 |
| 25 | SiO₂ | 88 | 176 | 9.3 |
| 26 | TiO₂ | 6 | 30 | 18.5 |
| 27 | TiO₂ | 10 | 50 | 26.7 |
| 28 | TiO₂ | 13 | 65 | 30.1 |
| 29 | TiO₂ | 19 | 95 | 27.9 |
| 30 | TiO₂ | 22 | 110 | 22.7 |
| 31 | TiO₂ | 26 | 130 | 13.9 |
| 32 | TiO₂ | 30 | 150 | 16.1 |
| 33 | TiO₂ | 32 | 160 | 17.5 |
| 34 | TiO₂ | 38 | 190 | 21.3 |
| 35 | TiO₂ | 40 | 200 | 21.1 |
| 36 | TiO₂ | 42 | 210 | 17.9 |
| 37 | TiO₂ | 45 | 225 | 17.7 |
| 38 | TiO₂ | 48 | 240 | 17.8 |
| 39 | TiO₂ | 50 | 250 | 18.1 |
| 40 | TiO₂ | 53 | 265 | 17.7 |
| 41 | TiO₂ | 55 | 275 | 18.4 |
| 42 | TiO₂ | 58 | 290 | 17.6 |
| 43 | TiO₂ | 60 | 300 | 18.6 |
| 44 | TiO₂ | 65 | 325 | 18.6 |

Retroreflective color was assessed for Comparative Examples 1, 6, 9, 11 and 13 according to Procedure C. Table 2A lists the color coordinates, observed color, distance from black body radiation curve between 4800K and 7500K and the coordinates for the closest point on the black body radiation curve between 4800K and 7500K. The designation “L/N” indicates little or no color was observed.

TABLE 2A

| | | | | Closest |
|---|---|---|---|---|
| | | | | point on |
| | | | Distance from | black body |
| | Chromaticity | | black body | curve (x, y), |
| | coordinate | | radiation curve | between |
| Comparative | measurements | Observed | between 4800K | 4800K and |
| Example | (x, y) | color | and 7500K | 7500K |
| 1 | 0.327, 0.34 | L/N | 0.0018 | 0.326, 0.341 |
| 6 | 0.318, 0.334 | L/N | 0.0004 | 0.318, 0.334 |
| 9 | 0.331, 0.346 | L/N | 0.0012 | 0.332, 0.347 |
| 11 | 0.341, 0.355 | L/N | 0.001 | 0.342, 0.355 |
| 13 | 0.344, 0.356 | L/N | 0.0007 | 0.344, 0.357 |

### Examples 45-69

Examples 45-69 employ the Type I bead cores. The retroreflective elements were prepared according to Procedure A so that the retroreflective elements included two concentric optical interference layers. Examples 45-60 were made using Type I bead cores coated with an inner or first optical interference layer of silica and an outer or second optical interference layer of titania. Examples 61-69 were made with Type I bead cores and were coated with an inner or first optical interference layer of titania and an outer or second optical interference layer of silica. Coating materials, thicknesses, and retroreflected brightness (Ra) of clear patch constructions are reported in Table 3.

TABLE 3

| | | Estimated | | Estimated | |
|---|---|---|---|---|---|
| | Inner | inner | Outer | outer | |
| | layer | layer | layer | layer | |
| | coating | thickness | coating | thickness | |
| Example | material | (nm) | material | (nm) | Ra (CP) |
| 45 | SiO₂ | 110 | TiO₂ | 30 | 46.1 |
| 46 | SiO₂ | 110 | TiO₂ | 50 | 56.4 |
| 47 | SiO₂ | 110 | TiO₂ | 60 | 58.4 |
| 48 | SiO₂ | 110 | TiO₂ | 80 | 56.7 |
| 49 | SiO₂ | 110 | TiO₂ | 100 | 56.6 |
| 50 | SiO₂ | 110 | TiO₂ | 125 | 51 |
| 51 | SiO₂ | 110 | TiO₂ | 150 | 42 |
| 52 | SiO₂ | 110 | TiO₂ | 165 | 35.2 |
| 53 | SiO₂ | 110 | TiO₂ | 180 | 32.7 |
| 54 | SiO₂ | 110 | TiO₂ | 200 | 35.9 |
| 55 | SiO₂ | 110 | TiO₂ | 215 | 41.7 |
| 56 | SiO₂ | 40 | TiO₂ | 50 | 31.2 |
| 57 | SiO₂ | 40 | TiO₂ | 75 | 42.4 |
| 58 | SiO₂ | 40 | TiO₂ | 100 | 44.4 |
| 59 | SiO₂ | 40 | TiO₂ | 125 | 28.5 |
| 60 | SiO₂ | 40 | TiO₂ | 135 | 27.1 |
| 61 | TiO₂ | 60 | SiO₂ | 40 | 40.1 |
| 62 | TiO₂ | 60 | SiO₂ | 50 | 45.4 |
| 63 | TiO₂ | 60 | SiO₂ | 60 | 49.4 |
| 64 | TiO₂ | 60 | SiO₂ | 70 | 51.6 |
| 65 | TiO₂ | 60 | SiO₂ | 80 | 51.3 |
| 66 | TiO₂ | 60 | SiO₂ | 90 | 47.1 |
| 67 | TiO₂ | 60 | SiO₂ | 100 | 43.8 |
| 68 | TiO₂ | 60 | SiO₂ | 110 | 37.4 |
| 69 | TiO₂ | 60 | SiO₂ | 120 | 26.1 |

Retroreflective color was assessed for Examples 45, 47, 49, 50, 52, 54 and 55 according to Procedure C. For the retroreflective elements of Examples 61-69, it is noted that the retroreflective colors in air (i.e., before submersion into a substrate) were different than the color observed after the elements were submerged into a substrate with an index of refraction in the range of 1.4 to 1.5 RI (i.e., similar to that of SiO2). Table 3A lists the color coordinates, observed color, distance from black body radiation curve between 4800K and 7500K and the coordinates for the closest point on the black body radiation curve between 4800K and 7500K. The designation “L/N” indicates little or no color was observed.

TABLE 3A

| | | | | Closest |
|---|---|---|---|---|
| | | | | point on |
| | | | Distance from | black body |
| | Chromaticity | | black body | curve (x, y) |
| | coordinate | | radiation curve | between |
| | measurements | Observed | between 4800K | 4800K |
| Example | (x, y) | color | and 7500K | and 7500K |
| 45 | 0.322, 0.347 | L/N | 0.0068 | 0.326, 0.341 |
| 47 | 0.343, 0.358 | L/N | 0.0017 | 0.344, 0.357 |
| 49 | 0.365, 0.382 | Light yellow | 0.0225 | 0.353, 0.363 |
| 50 | 0.384, 0.393 | yellow | 0.0431 | 0.353, 0.363 |
| 52 | 0.34, 0.312 | purple | 0.0314 | 0.32, 0.336 |
| 54 | 0.292, 0.332 | light blue | 0.0158 | 0.302, 0.320 |
| 55 | 0.313, 0.363 | light green | 0.0248 | 0.33, 0.345 |

### Examples 70-80

Examples 70-80 employed Type I bead cores as well as the same coating materials and used for the preparation of Examples 1-44. The retroreflective elements were prepared according to Procedure A with Examples 70-80 made to include three complete concentric interference layers. Coating materials, thicknesses, and retroreflected brightness (Ra) of clear patch constructions are reported in Table 4.

TABLE 4

| | Inner | Inner layer | Second | Second layer | Outer | Outer layer | Ra |
|---|---|---|---|---|---|---|---|
| Example | layer | thickness (nm) | layer | thickness (nm) | layer | thickness (nm) | (CP) |
| 70 | SiO₂ | 110 | TiO₂ | 60 | SiO₂ | 32 | 63 |
| 71 | SiO₂ | 110 | TiO₂ | 60 | SiO₂ | 52 | 79.1 |
| 72 | SiO₂ | 110 | TiO₂ | 60 | SiO₂ | 72 | 102 |
| 73 | SiO₂ | 110 | TiO₂ | 60 | SiO₂ | 92 | 113 |
| 74 | SiO₂ | 110 | TiO₂ | 60 | SiO₂ | 98 | 113 |
| 75 | SiO₂ | 110 | TiO₂ | 60 | SiO₂ | 106 | 109 |
| 76 | SiO₂ | 110 | TiO₂ | 60 | SiO₂ | 112 | 102 |
| 77 | SiO₂ | 110 | TiO₂ | 60 | SiO₂ | 116 | 95.1 |
| 78 | SiO₂ | 40 | TiO₂ | 110 | SiO₂ | 10 | 24 |
| 79 | SiO₂ | 40 | TiO₂ | 110 | SiO₂ | 20 | 26.9 |
| 80 | SiO₂ | 40 | TiO₂ | 110 | SiO₂ | 36 | 31.1 |

Retroreflective color was assessed according to Procedure C for Examples 70 and 72-75. Table 4A lists the color coordinates, observed color, distance from black body radiation curve between 4800K and 7500K and the coordinates of the closest point on the black body radiation curve between 4800K and 7500K. The designation “L/N” indicates little or no color was observed. It is noted that the colors in air (i.e., before submersion into a substrate) were very different that the colors observed after the retroreflective elements were submerged into a substrate with an index of refraction in the range of 1.4 to 1.5 RI (i.e., similar to that of SiO2).

TABLE 4A

| | | | | Closest |
|---|---|---|---|---|
| | | | | point on |
| | | | Distance from | black body |
| | Chromaticity | | black body | curve (x, y) |
| | coordinate | | radiation curve | between |
| | measurements | Observed | between 4800K | 4800K and |
| Example | (x, y) | color | and 7500K | 7500K |
| 70 | 0.332, 0.352 | L/N | 0.0042 | 0.334, 0.348 |
| 72 | 0.341, 0.372 | light yellow | 0.0138 | 0.35, 0.362 |
| 73 | 0.371, 0.394 | yellow | 0.036 | 0.353, 0.363 |
| 74 | 0.385, 0.399 | yellow- | 0.0487 | 0.353, 0.363 |
| | | orange | | |
| 75 | 0.4, 0.394 | orange | 0.057 | 0.353, 0.363 |

### Comparative Examples 81-95 and Examples 96-104

Comparative Examples 81-95 and Examples 96-104 were prepared in the same manner as in Comparative Examples 1-15 and Examples 45-53, respectively. Retroreflective color from these retroreflective elements was observed and recorded. Observed retroreflective color was determined by viewing through a retroreflective viewer (available under the trade designation “3M VIEWER” from 3M Company, St. Paul, Minn.). A layer of retroreflective elements was partially embedded in a polymer adhesive (3M Scotch 375 Clear Tape) to determine Clear Patch brightness. Table 5 summarizes the construction, observed retroreflective color and Clear Patch Brightness for the samples.

TABLE 5

| | | | | | | Retroreflective |
|---|---|---|---|---|---|---|
| | | | | | | color from clear |
| | Inner | Inner layer | Outer | Outer layer | Ra | patch |
| Sample | layer | thickness (nm) | layer | thickness (nm) | (CP) | constructions |
| C. Ex. 81 | uncoated | uncoated | uncoated | uncoated | 7.7 | L/N |
| C. Ex. 82 | SiO₂ | 36 | none | 0 | 9.76 | L/N |
| C. Ex. 83 | SiO₂ | 44 | none | 0 | 10.5 | L/N |
| C. Ex. 84 | SiO₂ | 52 | none | 0 | 11.7 | L/N |
| C. Ex. 85 | SiO₂ | 62 | none | 0 | 12.8 | L/N |
| C. Ex. 86 | SiO₂ | 68 | none | 0 | 13.5 | L/N |
| C. Ex. 87 | SiO₂ | 74 | none | 0 | 14.4 | L/N |
| C. Ex. 88 | SiO₂ | 80 | none | 0 | 15.1 | orange |
| C. Ex. 89 | SiO₂ | 88 | none | 0 | 16.1 | rust |
| C. Ex. 90 | SiO₂ | 96 | none | 0 | 17 | purple |
| C. Ex. 91 | SiO₂ | 104 | none | 0 | 17.5 | violet |
| C. Ex. 92 | SiO₂ | 110 | none | 0 | 17.1 | bluish violet |
| C. Ex. 93 | SiO₂ | 116 | none | 0 | 17 | blue |
| C. Ex. 94 | SiO₂ | 122 | none | 0 | 15.3 | blue |
| C. Ex. 95 | SiO₂ | 126 | none | 0 | 14.7 | bluish green |
| Ex. 96 | SiO₂ | 110 | TiO₂ | 30 | 46.1 | L/N |
| Ex. 97 | SiO₂ | 110 | TiO₂ | 50 | 56.4 | L/N |
| Ex. 98 | SiO₂ | 110 | TiO₂ | 60 | 58.4 | L/N |
| Ex. 99 | SiO₂ | 110 | TiO₂ | 80 | 56.7 | L/N |
| Ex. 100 | SiO₂ | 110 | TiO₂ | 100 | 56.6 | creamish yellow |
| Ex. 101 | SiO₂ | 110 | TiO₂ | 125 | 51 | yellow |
| Ex. 102 | SiO₂ | 110 | TiO₂ | 165 | 35.2 | red |
| Ex. 103 | SiO₂ | 110 | TiO₂ | 180 | 32.7 | purple |
| Ex. 104 | SiO₂ | 110 | TiO₂ | 215 | 35.9 | violet |

* L/N—little or no color observed in retroreflection

### Comparative Example 105-107 and Examples 108-110

White patch brightness measurements were made for several of the previously described retroreflective elements. Table 6 summarizes the construction of the retroreflective elements as well as White Patch Brightness for these samples.

TABLE 6

| | | | Outer | Estimated | |
|---|---|---|---|---|---|
| | Coated as | | layer | outer layer | |
| | in | | coating | thickness | Ra |
| Sample | Example | Layer sequence | material | (nm) | (WP) |
| C. Ex. 105 | 1 | none | uncoated | uncoated | 18.1 |
| C. Ex. 106 | 11 | SiO₂ | SiO₂ | 104 | 23.6 |
| C. Ex. 107 | 28 | TiO₂ | TiO₂ | 150 | 40.1 |
| Ex. 108 | 47 | SiO₂, TiO₂ | TiO₂ | 60 | 67 |
| Ex. 109 | 73 | SiO₂, TiO₂, SiO₂ | SiO₂ | 98 | 114 |
| Ex. 110 | 80 | SiO₂, TiO₂, SiO₂ | SiO₂ | 36 | 33 |

### Comparative Examples 111-123

Glass-ceramic bead cores were prepared according to the methods described in U.S. Pat. No. 6,245,700. The Type II bead cores had a composition of ZrO₂ 12.0%, Al₂O₃ 29.5%, SiO₂ 16.2%, TiO₂ 28.0%, MgO 4.8%, CaO 9.5% (wt %), with a refractive index of ˜1.89 and an average diameter about 60 um. The bead cores were coated with a single layer SiO₂ or TiO₂ according to Procedure A. The construction of the retroreflective elements and both Clear Patch Brightness and White Patch Brightness determinations are reported in Table 7.

TABLE 7

| | | Estimated | | |
|---|---|---|---|---|
| | | coating | | |
| Comparative | Coating | thickness | | |
| Example | material | (nm) | Ra (CP) | Ra (WP) |
| 111 | uncoated | uncoated | 3.1 | 15.2 |
| 112 | SiO₂ | 20 | 5.6 | 16.8 |
| 113 | SiO₂ | 36 | 4.71 | 16.2 |
| 114 | SiO₂ | 50 | 5.08 | 16.1 |
| 115 | SiO₂ | 64 | 5.45 | 16.4 |
| 116 | SiO₂ | 78 | 5.6 | 16.3 |
| 117 | SiO₂ | 92 | 5.7 | 17.6 |
| 118 | SiO₂ | 106 | 6.22 | 16.3 |
| 119 | TiO₂ | 40 | 11 | 19.3 |
| 120 | TiO₂ | 65 | 14.4 | 21.4 |
| 121 | TiO₂ | 95 | 12.1 | 23 |
| 122 | TiO₂ | 120 | 6.5 | 17.6 |
| 123 | TiO₂ | 150 | 6.4 | 16.8 |

### Comparative Examples 124-145

Bead cores designated as Type III were prepared according to the methods described in U.S. Pat. 6,245,700. The Type III bead cores were made of a glass-ceramic material having a composition of TiO₂ 61.3%, ZrO₂ 7.6%, La₂O₃ 29.1%, ZnO 2% by weight, with RI ˜2.4, and an average diameter of about 60 um. The bead cores were coated with single layer coatings of SiO₂ or TiO₂ according to Procedure A. Clear Patch Brightness and White Patch Brightness measurements were recorded by covering the patch surface with water. Coating materials, coating thicknesses and the wet White Patch and wet Clear Patch Brightness measurements are summarized in Table 8.

TABLE 8

| Comparative | Coating | Coating | | |
|---|---|---|---|---|
| Example | material | thickness (nm) | Wet Ra (CP) | Wet Ra (WP) |
| 124 | uncoated | 0 | 3.91 | 11.4 |
| 125 | SiO₂ | 36 | 4.8 | 11.5 |
| 126 | SiO₂ | 48 | 5.03 | 12.2 |
| 127 | SiO₂ | 60 | 5.3 | |
| 128 | SiO₂ | 72 | 5.83 | 13.6 |
| 129 | SiO₂ | 84 | 6.04 | |
| 130 | SiO₂ | 96 | 6.48 | 13.4 |
| 131 | SiO₂ | 108 | 6.54 | 13.5 |
| 132 | SiO₂ | 120 | 6.7 | 12.9 |
| 133 | SiO₂ | 132 | 5.7 | |
| 134 | SiO₂ | 144 | 6.09 | |
| 135 | SiO₂ | 156 | 5.44 | |
| 136 | SiO₂ | 168 | 5.1 | |
| 137 | SiO₂ | 180 | 4.5 | |
| 138 | TiO₂ | 30 | 4.12 | 11 |
| 139 | TiO₂ | 60 | 3.7 | 9.51 |
| 140 | TiO₂ | 90 | 2.73 | 11.7 |
| 141 | TiO₂ | 120 | 2.79 | 10.7 |
| 142 | TiO₂ | 162 | 3.6 | 11.6 |
| 143 | TiO₂ | 198 | 4.6 | 10.9 |
| 144 | TiO₂ | 240 | 3.75 | |
| 145 | TiO₂ | 288 | 3.1 | |

### Example 146

Three complete concentric optical interference layers were deposited on Type III bead cores according to Procedure A. Table 9 summarizes the coating materials, coating thicknesses and White Patch and Clear Patch Brightness measurements. The White Patch and Clear Patch Brightness measurements were made under wet conditions as in Examples 124-145.

TABLE 9

| | Inner layer | Inner layer | Second layer | Second layer | Outer layer | Outer layer | Wet Ra | Wet Ra |
|---|---|---|---|---|---|---|---|---|
| Example | coating material | thickness (nm) | coating material | thickness (nm) | coating material | thickness (nm) | (CP) | (WP) |
| 146 | SiO₂ | 120 | TiO₂ | 60 | SiO₂ | 110 | 11.3 | 17.2 |

### Procedures for Comparative Examples 147, 148 and Examples 149-152

Proceedure D: Single-Layer Retroreflective Elements: 60 micron diameter bead cores with an index of refraction ˜1.9 were coated with a single thin layer of TiO₂ as described in Procedure A and were used as Comparative Examples. Retroreflective elements of two different retroreflective colors were made: (1) yellow-orange (“yellow-orange retroreflective elements”) and (2) blue (“blue retroreflective elements”). In ambient light, there was no observed difference in color between these retroreflective elements, even after affixing them to an adhesive substrate.

Proceedure E: Three-Layer Retroreflective Elements: Retroreflective elements were prepared according to Procedure A and were used as Examples herein. 60 micron diameter bead cores with an index of refraction ˜1.9 were coated to provide a first complete concentric optical interference layer of TiO₂, a second complete concentric optical interference layer of SiO₂, and a third complete concentric optical interference layer of TiO₂. The resulting retroreflective elements were of three different retroreflective colors: (1) yellow, (2) turquoise, and (3) purple. In ambient light, there was no observed difference in color between these three-layer retroreflective elements and the single-layer retroreflective elements, even after affixing them to an adhesive substrate.

Proceedure F: Extrusion Process for Substrate

Films of Fusabond MC190D ethylene vinyl acetate (EVA) (DuPont) and Primacor 3340 ethylene acrylic acid copolymer (Dow) were produced using a cast film extrusion process. Resin pellets were fed into a 1.9 cm (¾ in) single screw extruder manufactured by C. W. Brabender Instruments Inc., South Hackensack, N.J., with a temperature profile from 185° C. (365° F.) to 200° C. (392° F.) resulting in a melt temperature of about 200° C. (392° F.). A horizontal die was used to cast the films onto a polyethylene terephthalate (PET) base film approximately 15 cm (6 in) wide and 0.05 mm (0.002 in) thick traveling at approximately 3 meters/min (10 ft/min). The resulting film construction was run between a steel chill roll and a rubber backup roll to solidify the molten resin into a layer having a thickness of approximately 0.1 mm (0.004 in), and wound to form a roll. The extruded films are referred to as “substrate.”

Proceedure G: Printing Process for “Imaged Retroreflective Elements”

“Image retroreflective elements” were printed onto a specific region of substrate. The image retroreflective elements are used for contrast purposes with the “matrix retroreflective elements” which cover the remainder of the substrate. Stamp printing was used to print image retroreflective elements on the substrate wherein a rubber stamp was used to transfer a very thin layer of UV-curable binding resin (available under the designation “CG 9720” from 3M Company) with no colorant added to the resin. Immediately following the printing, image retroreflective elements were sprinkled over the printed regions (when more than one color was used, image retroreflective elements of different colors were carefully sprinkled over the desired regions). The printed samples were then passed under a strong UV light source at 100 fpm, exposing the sample to 0.25 J/cm². The sample was then brushed gently using a soft paint brush to remove excess retroreflective elements.

Procedure H: Flood-Coating Process for “Matrix Retroreflective Elements”

This process was used to coat the retroreflective elements for a matrix over the surface of a substrate. When image retroreflective elements were present in a pattern, matrix retroreflective elements were added as contrast for viewing the image retroreflective elements in retroreflective lighting conditions. Retrochromic image retroreflective elements were sprinkled liberally over the surface of a substrate, and the substrate was heated for 3 minutes in a convection oven set at a temperature of 150° C. The substrate was removed from the oven, allowed to cool for 30 seconds, then brushed vigorously using a stiff bristle brush to remove excess retroreflective elements and resulting in a single layer of retroreflective elements bonded to the top of the substrate. The substrate was then run through a laminator (model 6060P by SDIS) set between 325° F. (nearest the front) and 350° F. (nearest the back) at moderate pressure at a speed of 1.5 fpm in order to sink the retroreflective elements into the substrate to a depth greater than 20% of their diameter.

Procedure I: Retroreflective Contrast Measurements

Three different techniques were used to measure the retroreflectivity and retroreflective contrast of these materials.
I(1) Hiding power: In a lit room (e.g., normal office lighting), sample was placed over a piece of standard copy paper with an address written on it. The sample was rated poor, fair, good, or excellent based on how well the address can be seen when using the viewer. For example, if the address was clearly visible when illuminated with a retroreflective source such as a 3M Viewer, the sample would rate as “poor.” If the address was completely hidden by the retroreflective nature of the substrate, the sample would rate as “excellent.”

I(2) 3M Viewer contrast: In a lit room (e.g., normal office lighting), the sample was placed over a piece of standard copy paper with an address written on it. If the retroreflective logo was clearly visible using a 3M retroviewer, the sample passed the 3M Viewer contrast test. Samples were rated “poor,” “fair,” “good,” or “excellent” based on how obvious the retroreflective image was. If the image is instantly obvious when illuminated with a retroreflective source such as a 3M Viewer, the sample would rate as “excellent.” If the image was invisible or the sample had to be manipulated to see the image, the sample would rate as “poor.”
I(3) Flashlight contrast: In a lit room (e.g., normal office lighting), a sample was placed over a piece of standard copy paper with an address written on it. A bright flashlight was placed alongside the viewer's head so that the beam of the flashlight was focused on the retroreflective artwork. If the retroreflective logo was clearly visible, the sample passed the flashlight contrast test. The sample was rated “poor,” “fair,” “good,” or “excellent” based on how obvious the retroreflective image was. If the image was instantly obvious when illuminated with a retroreflective source such as a 3M Viewer, the sample would rate as “excellent.” If the image was invisible or the sample had to be manipulated to see the image, the sample would rate as “poor.”

### Comparative Example 147

Yellow-orange retroreflective elements were made according to Procedure D. The elements were printed onto a Fusabond MC 190D EVA substrate prepared according to Procedure F using the stamp-printing process of Procedure G using a stamp in the shape of a stingray. The flood-coating process (Procedure H) was used to put yellow-orange elements onto the remainder of the substrate. Hiding power, 3M Viewer contrast and flashlight contrast were evaluated according to Procedures I(1)-(3). The hiding power of this material was fair; the 3M Viewer contrast was poor; the flashlight contrast was very poor.

### Comparative Example 148

Blue retroreflective elements were made according to Procedure D. The elements were printed onto a Fusabond MC190D EVA substrate prepared according to Procedure F using the stamp-printing process of Procedure G using a stamp in the shape of a stingray. The flood-coating process (Procedure H) was used to put yellow-orange elements onto the remainder of the substrate. Hiding power, 3M Viewer contrast and flashlight contrast were evaluated according to Procedures I(1)-(3). The hiding power of this material was fair; the 3M Viewer contrast was fair; the flashlight contrast was fair.

### Example 149

Three-layer yellow retroreflective elements were made according to Procedure E. The elements were printed onto a Fusabond MC190D EVA substrate prepared according to Procedure F using the stamp-printing process of Procedure G using a stamp in the shape of a stingray. The flood-coating process (Procedure H) was used to put yellow retroreflective elements on the remainder of the substrate. Hiding power, 3M Viewer contrast and flashlight contrast were evaluated according to Procedures I(1)-(3). The hiding power of this material was fair; the 3M Viewer contrast was excellent; the flashlight contrast was very good.

### Example 150

Three-layer turquoise retroreflective elements were made according to Procedure E. The elements were printed onto a Fusabond MC190D EVA substrate prepared according to Procedure F using the stamp-printing process of Procedure G using a stamp in the shape of a stingray. The flood-coating process (Procedure H) was used to put yellow retroreflective elements onto the remainder of the substrate. Hiding power, 3M Viewer contrast and flashlight contrast were evaluated according to Procedures I(1)-(3). The hiding power of this material was fair; the 3M Viewer contrast was excellent; the flashlight contrast was excellent.

### Example 151

Three-layer turquoise retroreflective elements were made according to Procedure E. The elements were printed onto a Fusabond MC190D EVA substrate prepared according to Procedure F using the stamp-printing process of Procedure G using a stamp in the shape of a stingray. The flood-coating process (Procedure H) was used to put three-layer yellow elements on the remainder of the substrate. Hiding power, 3M Viewer contrast and flashlight contrast were evaluated according to Procedures I(1)-(3). The hiding power of this material was excellent; the 3M Viewer contrast was excellent; the flashlight contrast was excellent.

### Example 152

Three-layer turquoise retroreflective elements and three-layer purple retroreflective elements were prepared according to Procedure E and printed onto a Fusabond MC190D EVA substrate prepared according to Procedure F using the stamp-printing process of Procedure G using a stamp in the shape of a stingray such that different portions of the stingray were of different colors. The flood-coating process (Procedure H) was used to put three-layer yellow elements on the remainder of the substrate. Hiding power, 3M Viewer contrast and flashlight contrast were evaluated according to Procedures I(1)-(3). The hiding power of this material was excellent; the 3M Viewer contrast was excellent; the flashlight contrast was excellent. In addition, using either the 3M Viewer or the flashlight, the two-tone color of the stingray was immediately obvious and striking.

### Example 153

A screen-printing operation was used to deposit retroreflective elements on a substrate as in Example 152. The screen provided a printed stingray indicia. The screen printer was used to transfer a very thin layer of UV-curable binding resin (available under the designation “CG 9720” from 3M Company) with no colorant added to the resin. Immediately following printing, image retroreflective elements from Example 152 were sprinkled over the printed regions. The printed samples were then passed under a strong UV light source at 100 fpm, exposing the sample to 0.25 J/cm². The sample was then brushed gently using a soft paint brush to remove excess retroreflective elements. The flood-coating process (Procedure H) was used to put three-layer yellow matrix retroreflective elements on the remainder of the substrate. The hiding power, 3M viewer contrast, and flashlight contrast were the same as in Example 151. The printed resolution of the stingray was observed to be better than that of Example 151.

### Example 154

The process and materials described in Example 153 were replicated, except that the retroreflective elements described in Example 73 were used as the matrix retroreflective elements and were submerged to a level between 30 and 50%. The elements retroreflected a blue color prior to submersion into the substrate and yellow after submersion when viewed at an angle normal to the substrate. In addition, after submersion, the matrix retroreflective elements showed a distinct yellow-to-blue retroreflective color shift when tilted away from the normal. This additional covert security feature still had the same hiding power of the normally viewed feature, which was as good as that of Example 153.

Embodiments of the invention have been described in some detail. Those skilled in the art will appreciate that the invention is not to be limited to the described embodiments, and that various changes and modifications can be made to the embodiments without departing from the spirit and scope of the invention.

What is claimed is:

1. A security laminate comprising:
A first substrate having a first major surface and a second major surface;
A plurality of retroreflective elements affixed along the first major surface of the substrate, the retroreflective elements comprising:
a solid spherical core comprising an outer core surface, the outer core surface providing a first interface;
a first complete concentric optical interference layer having an inner surface overlying the core surface and an outer surface, the outer surface of the first complete concentric optical interference layer providing a second interface;
a second complete concentric optical interference having an inner surface overlying the outer surface of the first complete concentric optical interference layer and an outer surface, the outer surface of the second complete concentric optical interference layer providing a third interface; and
the security article is retroreflective.

2. The security laminate according to claim 1 wherein the first substrate comprises a polymer.

3. The security laminate according to claim 1, the article comprising no auxiliary reflector, having a coefficient of retroreflection, measured at −4 degrees entrance angle and 0.2 degrees observation angle, greater than 50 Cd/lux/m² and a retroreflective color with chromaticity coordinates defining a point on the CIE chromaticity diagram (1931 version) that lies within 0.01 of the line that describes black body emission between 4800K and 7500K.

4. The security laminate according to claim 2 wherein the polymer is crosslinked along the first major surface of the first substrate.

5. The security laminate according to claim 4 wherein the polymer is crosslinked in a gradient, the polymer being more extensively crosslinked along the first major surface of the first substrate than along the second major surface.

6. The security laminate according to claim 2 wherein the retroreflective elements are embedded into the first major surface of the first substrate.

7. The security laminate according to claim 6 further comprising silane coupling agent bonded to the retroreflective elements and the first major surface of the first substrate.

8. The security laminate according to claim 6, further comprising an auxiliary reflector disposed between the first major surface of the first substrate and the retroreflective elements.

9. The security laminate according to claim 8, wherein the auxiliary reflector comprises a dielectric stack of thin films.

10. The security laminate according to claim 6, further comprising a radiation sensitive material layer disposed between the first major surface of the first substrate and the retroreflective elements, the radiation sensitive material being imaged so that a floating image appears above or below the laminate when viewed in retroreflective mode.

11. The security laminate according to claim 1, wherein the retroreflective elements cover a first portion of the first major surface.

12. The security laminate according to claim 11, wherein the first portion of the major surface has a coefficient of retroreflection, measured at −4 degrees entrance angle and 0.2 degrees observation angle, of at least 50 Cd/lux/m² and wherein there is no auxiliary reflector present behind the retroreflective elements.

13. The security laminate according to claim 12, wherein a second portion of the first major surface is covered by retroreflective elements, the second portion having a coefficient of retroreflection, measured at −4 degrees entrance angle and 0.2 degrees observation angle, that differs from that of the first portion by at least 10 percent of the value for the first portion.

14. The security laminate according to claim 1, wherein the laminate exhibits a coefficient of retroreflection value at least 4 times greater than that of an otherwise identical laminate comprising retroreflective elements consisting of the solid spherical core having no complete concentric optical interference layers thereon.

15. The security laminate according to claim 11, wherein the retroreflective elements cover a first portion of the first major surface and the remainder of the laminate includes additional security features.

16. The security laminate according to claim 15, wherein the retroreflective elements cover a first portion of the first major surface and the remainder of the first major surface comprises other security features.

17. The security laminate according to claim 16, wherein the other security features are selected from a diffractive optically variable image device (DOVID), a hologram, a color shifting film, or both.

18. The security laminate according to claim 1 wherein the retroreflective elements provide retroreflective color when viewed in the retroreflective mode.

19. The security laminate of claim 1, wherein a region of the major surface exhibits a first retroreflective color when viewed normal to the first major surface and exhibits a second retroreflective color when viewed at a sufficiently large angle from the normal, the first retroreflective color and the second retroreflective color being different.

20. The security laminate according to claim 1, wherein the retroreflective elements further comprise a third complete concentric optical interference layer overlying the second surface of the second complete concentric optical interference layer, the third complete concentric optical interference layer having an inner surface overlying the outer surface of the second complete concentric optical interference layer and an outer surface, the outer surface of the third complete concentric optical interference layer providing a fourth interface, the fourth interface being at least partially reflective of incident light.

21. The security laminate according to claim 20 wherein the retroreflective elements exhibit enhanced retroreflective brightness with retroreflective color.

22. The security laminate according to claim 20 wherein the retroreflective elements provide retroreflective color.

23. The security laminate according to claim 20, wherein the first optical interference layer, the second optical interference layer and the third optical interference layer each comprise material selected from the group consisting of TiO₂, SiO₂, ZnS, CdS, CeO₂, ZrO₂, Bi₂O₃, ZnSe, WO₃, PbO, ZnO, Ta₂O₅, Al₂O₃, B₂O₃, MgO, AlF₃, CaF₂, CeF₃, LiF, MgF₂, Na₃AlF₆, and combinations of two or more of the foregoing.

24. The security laminate according to claim 20, wherein the first optical interference layer is silica, the second optical interference layer is titania and the third optical interference layer is silica.

25. The security laminate according to claim 20, wherein the first optical interference layer is titania, the second optical interference layer is silica and the third optical interference layer is titania.

26. The security laminate according to claim 20, wherein the retroreflective elements cover a first portion of the first major surface, wherein the first portion of the major surface has a coefficient of retroreflection, measured at −4 degrees entrance angle and 0.2 degrees observation angle, of at least 100 Cd/lux/m² and wherein there is no auxiliary reflector present behind the retroreflective elements. (as supported by examples 72-76).

27. The security laminate according to claim 1 wherein adhesive is applied to the second major surface of the first substrate.

28. The security laminate according to claim 27 wherein the adhesive is a hot-melt adhesive.

29. The security laminate according to claim 27 wherein the adhesive is a pressure-sensitive adhesive.

30. A security article comprising the security laminate according to claim 1, the second major surface of the first substrate affixed to a major surface of a second substrate.

31. The security article according to claim 30 wherein the security laminate further comprises a tamper indicating layer applied to the second major surface of the first substrate.

32. The security article according to claim 31 wherein a first portion of the retroreflective elements are affixed along the first major surface of the first substrate in a first region; and wherein a second portion of the retroreflective elements are affixed along the first major surface of the first substrate in a second region, the first portion of retroreflective elements providing a level of retroreflective brightness and the second portion of retroreflective elements providing a second level of retroreflective brightness, the security laminate being transparent in diffuse lighting.

33. The security article according to claim 30 wherein a first portion of the retroreflective elements are affixed along the first major surface of the first substrate in a first region; and wherein a second portion of the retroreflective elements are affixed along the first major surface of the first substrate in a second region, the first portion of retroreflective elements providing a first retroreflective color and the second portion of retroreflective elements providing a second retroreflective color, the security laminate being transparent in diffuse lighting.

34. The security article according to claim 33 further comprising data associated with the major surface of the second substrate and the second major surface of the first substrate comprises data, the laminate affixed to the major surface of the second substrate over the data so that the data is viewable through the laminate in diffuse lighting.

35. The security article according to claim 34 wherein the data comprises personalization data.

36. The security article according to claim 34 wherein the major surface of the second substrate comprises a fragile layer, and the data is affixed to the fragile layer.

37. The security article according to claim 30 wherein the security article is selected from the group consisting of currency, a title document, a stock certificate, a credit card, a debit card, an identity card or a passport.
